(19) United States
(12) Patent Application Publication
(10) Pub. No.: US 2005/0030438 A1
(43) Pub. Date: Feb. 10, 2005

(54) Variable optical-property element

(75) Inventor: Kimihiko Nishioka, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/897,205

(22) Filed: Jul. 23, 2004

(30) Foreign Application Priority Data
Aug. 8, 2003 (JP) 2003-290488
Dec. 19, 2003 (JP) 2003-422383

(51) Int. Cl. G02F 1/133; G02F 1/1337

(52) U.S. Cl. 349/21

(57) ABSTRACT

A variable optical-property element includes a plurality of electrodes, a substrate which is driven by an electric force and can be deformed into a convex shape, an electrode constructed integrally with the substrate, an optical surface provided on the substrate, and a driving circuit connected to the electrodes.

### BACKGROUND OF THE INVENTION

1. Field of the Invention

This invention relates to a variable optical-property element, for example, a deformable mirror or a variable focal-length lens, in which optical properties, such as a focal length and aberration, are changed by altering the function of optical deflection.

2. Description of Related Art

Various deformable mirrors and variable focal-length lens have been proposed (refer to, for example, Japanese Patent Kokai Nos. 2000-267010, 2001-208905, 2002-189172, and 2003-177335, U.S. Pat. No. 6,384,952, and Optic Communication, Vol. 140, p. 187 (1997)).

However, very little is known about a conventional variable optical-property element constructed so that its optical surface can be deformed into a convex shape. For such a variable optical-property element, an electromagnetic force driving type is known. A variable optical-property element using a piezoelectric element is also available.

### SUMMARY OF THE INVENTION

The variable optical-property element according to the present invention includes a plurality of electrodes, a substrate which is driven by an electric force and can be deformed into a convex shape, an electrode constructed integrally with the substrate, an optical surface provided on the substrate, and a driving circuit connected to the electrodes.

The variable optical-property element according to the present invention includes a deformable optical surface, a first electrode constructed integrally with the optical surface, and a second electrode and a third electrode, placed on both sides of the optical surface, at least one of which has an opening for transmitting a utilization light beam. In this case, voltage or current is applied across the first and second electrodes or across the first and third electrodes, thereby changing the property of optical deflection.

The variable optical-property element is a variable mirror.

The variable optical-property element according to the present invention includes a deformable optical surface; a first electrode divided into a plurality of segments, provided integrally with the optical surface; and a second electrode divided into a plurality of segments, provided on one side of the optical surface. In this case, electric charges of identical signs are stored in at least one set of the first and second electrode, each of which is divided into the plurality of segments, thereby generating the electric force between the divided electrodes to deform the optical surface.

The variable optical-property element according to the present invention includes a deformable optical surface, a first electrode provided integrally with the optical surface, and a second electrode provided on one side of the optical surface. The first electrode or the second electrode is divided into a plurality of segments, between which alternating voltage or current is applied, thereby generating a repulsive force or electric force between the first electrode and the second electrode to deform the optical surface.

The variable optical-property element according to the present invention includes a deformable optical surface, a first electrode provided integrally with the optical surface, and a second electrode provided on one side of the optical surface. Each of the first electrode and the second electrode is divided into a plurality of segments, between which alternating voltage or current is applied, and thereby a repulsive force or electric force is generated between the first electrode and the second electrode so that the optical surface is deformed and at the same time, a resistor is provided between divided electrodes to which the alternating voltage is not applied.

The variable optical-property element according to the present invention includes a deformable optical surface, a first electrode provided integrally with the optical surface, and a second electrode provided on at least one side of the optical surface. The voltage or current is applied to the first electrode or the second electrode, thereby changing the property of optical deflection. In this case, an electrode provided integrally with a deformable substrate is not parallel with an electrode provided on another electrode.

The variable optical-property element according to the present invention can be used for compensation for shake of the optical apparatus.

The variable optical-property element according to the present invention can be used for compensation for one of a temperature change, a humidity change, a manufacturing error, and a change with age of the optical apparatus.

The variable optical-property element according to the present invention is designed to satisfy the following condition:
0.000001≦t/\sqrt{w}≦10000
where t is the thickness of each of the first electrode and the second electrode and w is its area.

The optical apparatus according to the present invention includes an optical system provided with a variable optical-property element having a plurality of divided electrodes so that a voltage distribution different from the symmetrization of the optical system can be imparted to the electrodes.

The variable optical-property element of the present invention includes a deformable optical surface, a first electrode provided integrally with the optical surface, and a second electrode provided on one side of the optical surface in such a way that a utilization light beam is partially blocked. The voltage or current is applied between the first electrode and the second electrode and thereby the property of optical deflection can be changed.

The variable optical-property element according to the present invention includes a deformable optical surface and a plurality of electrodes provided integrally with the optical surface. The optical surface is deformed by an electric force generated between the electrodes so that the property of optical deflection can be changed.

The variable optical-property element according to the present invention is designed to store electric charges of different signs in the plurality of electrodes.

The variable optical-property element according to the present invention includes a deformable optical surface with conductivity and a plurality of electrodes provided integrally with the optical surface. The optical surface with conductivity is divided in accordance with the plurality of electrodes.

The variable optical-property element according to the present invention is constructed so that the deformable optical surface has conductivity, and the optical surface with conductivity is divided in accordance with the first electrode.

The variable optical-property element according to the present invention includes a deformable optical surface, a first electrode provided integrally with the optical surface, and a second electrode provided on one side of the optical surface so that an electric force or repulsive force is generated by applying electric charges of identical signs between the first electrode and the second electrode, and the property of optical deflection can be changed.

The variable optical-property element according to the present invention includes a deformable optical surface, a first electrode provided integrally with the optical surface, and a second electrode provided on one side of the optical surface so that an electric force or repulsive force is generated by applying current or voltage between the first electrode and the second electrode, and the property of optical deflection can be changed.

The variable optical-property element according to the present invention includes a deformable optical surface; a first electrode divided into a plurality of segments, provided integrally with the optical surface; and a second electrode divided into a plurality of segments, provided on one side of the optical surface so that a repulsive force is generated between divided electrodes by storing electric charges of identical signs between the first and second electrodes divided practically opposite to each other, and the optical surface is deformed.

The variable mirror according to the present invention includes a deformable portion having a reflecting surface and a substrate, and an electrode placed opposite to the substrate so that the reflecting surface is divided into a plurality of segments and is driven by an electric force.

The variable mirror according to the present invention includes a deformable portion having a reflecting surface and a substrate, and an electrode placed opposite to the substrate so that the reflecting surface is divided into a plurality of segments, has an electrode function, and is driven by an electric force.

The variable mirror according to the present invention includes a deformable reflecting surface so that the reflecting surface can be deformed into either a convex or concave shape and at least one of a fluid, electrostatic force, electric field, electromagnetic force, piezoelectric effect, magnetrostriction, temperature change, and electromagnetic wave are used to deform the reflecting surface.

The variable mirror according to the present invention includes a deformable reflecting surface so that the reflecting surface can be deformed into either a convex or concave shape and when the reflecting surface is deformed into a convex shape, the pressure of the fluid is used, while when it is deformed into a concave shape, the electric force is used.

The imaging apparatus according to the present invention includes a variable mirror provided with a deformable reflecting surface so that when the surface profile of the variable mirror is flat, an object at a distance that the far point of the depth of field becomes nearly infinite is brought to a focus.

The imaging apparatus according to the present invention includes a variable mirror that the reflecting surface assumes both concave and convex shapes in a focusing process.

The variable focal-length lens according to the present invention includes a deformable optical surface so that the optical surface can be deformed into either a convex or concave shape and at least two of a fluid, electrostatic force, electric field, electromagnetic force, piezoelectric effect, magnetrostriction, temperature change, and electromagnetic wave are used to deform the optical surface.

The variable focal-length lens according to the present invention includes a deformable optical surface so that the optical surface can be deformed into either a convex or concave shape and when the optical surface is deformed into a convex shape, the pressure of the fluid is used, while when it is deformed into a concave shape, the electric force is used.

The imaging apparatus according to the present invention includes a variable focal-length lens provided with a deformable optical surface so that when the surface profile of the variable focal-length lens is flat, an object at a distance that the far point of the depth of field becomes nearly infinite is brought to a focus.

The imaging apparatus according to the present invention includes a variable focal-length lens provided with a deformable optical surface so that when the surface profile of the variable focal-length lens is flat, an object at any distance from the infinity to 0.5 meters is brought to a focus.

The imaging apparatus according to the present invention includes a variable focal-length lens that the optical surface assumes both concave and convex shapes in a focusing process.

The optical apparatus according to the present invention includes a variable optical-property element, a shake sensor, and an image sensor. The variable optical-property element includes a deformable optical surface, a first electrode constructed integrally with the optical surface, and a second electrode and a third electrode, placed on both sides of the optical surface, at least one of which has an opening for transmitting a utilization light beam. The voltage or current is applied across the first electrode and the second electrode or across the first electrode and the third electrode, thereby changing a property of optical deflection. In this case, the optical surface of the variable optical-property element is deformed and thereby compensation for shake is made.

The optical apparatus according to the present invention has a variable optical-property element. The variable optical-property element includes a deformable optical surface, a first electrode constructed integrally with the optical surface, and a second electrode and a third electrode, placed on both sides of the optical surface, at least one of which has an opening for transmitting a utilization light beam. The voltage or current is applied across the first electrode and the second electrode or across the first electrode and the third electrode, thereby changing a property of optical deflection. In this case, the optical surface of the variable optical-property element is deformed and thereby at least one of a temperature change, a humidity change, a manufacturing error, and a change with age is compensated.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a sectional view showing the structure of one embodiment of the variable optical-property element according to the present invention;

FIG. 2 is a plan view showing one example of the division pattern of electrodes;

FIG. 3 is a view showing one example of deformation of a reflecting surface in the embodiment of FIG. 1;

FIG. 4A is a view showing another example of deformation of the reflecting surface in the embodiment of FIG. 1;

FIG. 4B is a plan view showing another example of the division pattern of electrodes;

FIG. 5 is a sectional view showing the structure of another embodiment of the variable optical-property element according to the present invention;

FIG. 6 is a sectional view showing the structure of still another embodiment of the variable optical-property element according to the present invention;

FIG. 7 is a sectional view showing the structure of the embodiment of FIG. 6 using another driving circuit;

FIG. 8 is an explanatory view showing a state where electric charges are stored in the embodiment of FIG. 7;

FIG. 9 is a sectional view showing the structure of the embodiment of FIG. 6 using still another driving circuit;

FIG. 10 is a sectional view showing the structure of an modified example of the embodiment of FIG. 6;

FIG. 11 is an explanatory view showing a state where electric charges are stored in the embodiment of FIG. 9;

FIGS. 12A, 12B, and 12C are plan views showing examples of division patterns of electrodes different from one another;

FIG. 13 is a sectional view showing the structure of the embodiment of FIG. 6 using a further driving circuit;

FIG. 14 is an explanatory view showing a state where electric charges are stored in the embodiment of FIG. 13;

FIG. 15 is a sectional view showing the structure of the embodiment of FIG. 6 using a still further driving circuit;

FIG. 16 is a sectional view showing the structure of a further embodiment of the variable optical-property element according to the present invention;

FIG. 17 is a view showing schematically another example of a deformable mirror as the variable optical-property element applicable to the optical system used in the optical apparatus of the present invention;

FIG. 18 is a view showing schematically still another example of the deformable mirror;

FIG. 19 is an explanatory view showing one aspect of electrodes used in the deformable mirror of each of FIGS. 17 and 18;

FIG. 20 is an explanatory view showing another aspect of electrodes used in the deformable mirror of each of FIGS. 17 and 18;

FIG. 21 is a view showing schematically another example of the deformable mirror;

FIG. 22 is a view showing schematically another example of the deformable mirror;

FIG. 23 is a view showing schematically another example of the deformable mirror;

FIG. 24 is an explanatory view showing the winding density of a thin-film coil in the example of FIG. 23;

FIG. 25 is a view showing schematically another example of the deformable mirror;

FIG. 26 is an explanatory view showing one example of an array of coils in the example of FIG. 25;

FIG. 27 is an explanatory view showing another example of the array of coils in the example of FIG. 25;

FIG. 28 is an explanatory view showing an array of permanent magnets suitable for the array of coils of FIG. 27 in the example of FIG. 23;

FIG. 29 is a view showing schematically another example of the deformable mirror according to the present invention;

FIG. 30 is a view showing schematically the deformable mirror in which a fluid is taken in and out by a micropump to deform a lens surface;

FIG. 31 is a view showing schematically one example of the micropump;

FIG. 32 is a view showing the principle structure of the variable focal-length lens according to the present invention;

FIG. 33 is a view showing the index ellipsoid of a nematic liquid crystal of uni-axial anisotropy;

FIG. 34 is a view showing a state where an electric field is applied to a macro-molecular dispersed liquid crystal layer in FIG. 32;

FIG. 35 is a view showing an example where a voltage applied to the macro-molecular dispersed liquid crystal layer in FIG. 32 can be changed;

FIG. 36 is a view showing an example of an imaging optical system for digital cameras which uses the variable focal-length lens according to the present invention;

FIG. 37 is a view showing an example of a variable focal-length diffraction optical element as the variable optical-property element according to the present invention;

FIG. 38 is a view showing variable focal-length spectacles, each having a variable focal-length lens which uses a twisted nematic liquid crystal;

FIG. 39 is a view showing the orientation of liquid crystal molecules where a voltage applied to the twisted nematic liquid crystal layer of FIG. 38 is increased;

FIGS. 40A and 40B are views showing two examples of variable deflection-angle prisms as the variable optical-property element according to the present invention;

FIG. 41 is a view for explaining the applications of the variable deflection-angle prisms shown in FIGS. 40A and 40B;

FIG. 42 is a view showing schematically an example of a variable focal-length mirror which functions as the variable focal-length lens according to the present invention;

FIG. 43 is a view showing schematically an imaging optical system using the variable focal-length lens according to the present invention;

FIG. 44 is an explanatory view showing a modified example of the variable focal-length lens of FIG. 43;

FIG. 45 is an explanatory view showing a state where the variable focal-length lens of FIG. 44 is deformed;

FIG. 46 is a view showing schematically another example of the variable focal-length lens according to the present invention, in which a fluid is taken in and out by the micropump to deform a lens surface;

FIG. 47 is a view showing schematically another example of the variable optical-property element according to the present invention, which is the variable focal-length lens using a piezoelectric substance;

FIG. 48 is an explanatory view showing a state where the variable focal-length lens of FIG. 47 is deformed;

FIG. 49 is a view showing schematically still another example of the variable optical-property element according to the present invention, which is the variable focal-length lens using two thin plates constructed of piezoelectric substances;

FIG. 50 is a view showing schematically still another example of the variable focal-length lens according to the present invention;

FIG. 51 is an explanatory view showing the deformation of the variable focal-length lens of FIG. 50;

FIG. 52 is a view showing schematically a further example of the variable optical-property element according to the present invention, which is the variable focal-length lens using a photonical effect;

FIGS. 53A and 53B are explanatory views showing the structures of trans-type and cis-type azobenzene, respectively, used in the variable focal-length lens in FIG. 52;

FIG. 54 is a view showing schematically another example of the deformable mirror according to the present invention; and

FIGS. 55A and 55B are a side view showing an electromagnetically-driven variable mirror according to the present invention and a view looking from the opposite side of a reflecting film, respectively.

### DETAILED DESCRIPTION OF THE PREFERRED EMBODIMENTS

In accordance with the embodiments shown in the drawings, the present invention will be described below.

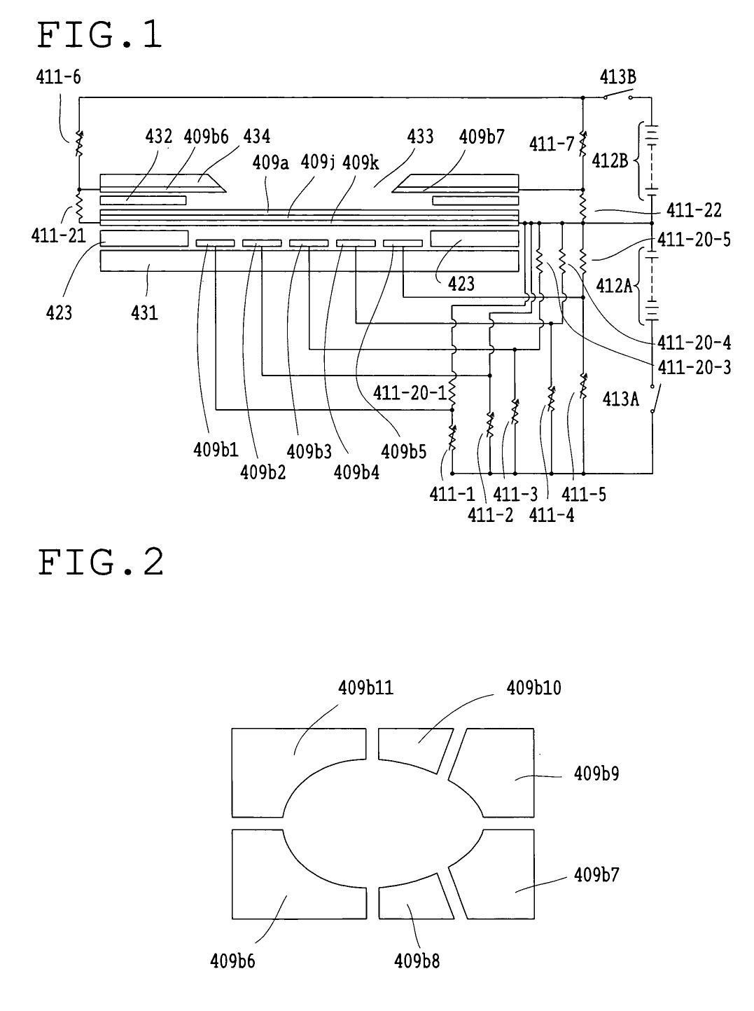

FIG. 1 shows one embodiment of the variable optical-property element according to the present invention.

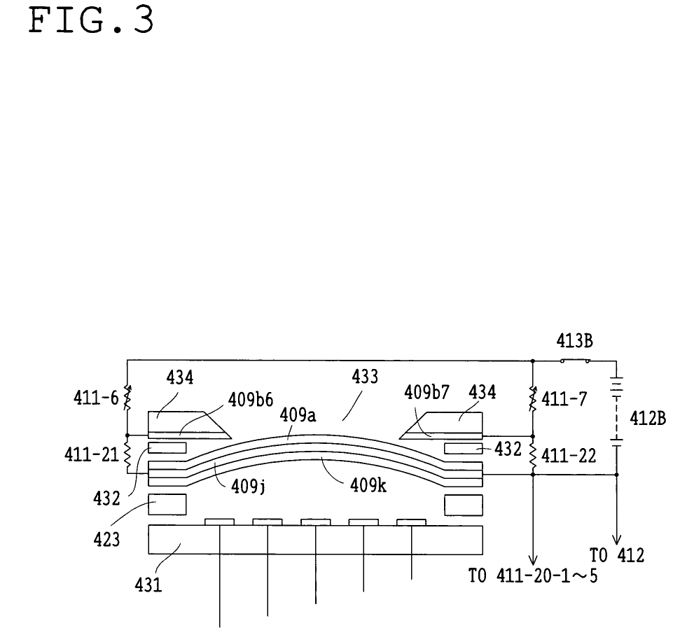

This embodiment is constructed as an electrostatically-driven deformable mirror which can be deformed into both the concave and convex shapes. In this deformable mirror, a thin film 409a formed as the reflecting surface (the optical surface), a deformable substrate 409j, and a deformable electrode plate 409k are laminated and the periphery of the mirror is mounted on a lower substrate 431 through a supporting base 423. Between the lower substrate 431 and the electrode plate 409k, fixed electrodes 409b1, 409b2, 409b3, 409b4, and 409b5 are arranged on the lower substrate 431. On the thin film 409a, a holding frame 432 opposite to the supporting base 423, fixed electrodes 409b6 and 409b7, and an upper substrate 434 are laminated at the periphery. An opening 433 for incidence and emergence of a light beam is provided in the middle of the upper substrate 434. The fixed electrodes 409b6 and 409b7, as shown in FIG. 2, are arranged around the opening 433, together with other divided, fixed electrodes 409b8, 409b9, 409b10, and 409b11. The fixed electrodes 409b1, 409b2, 409b3, 409b4, and 409b5, as shown in the figure, are connected with the electrode plate 409k by variable resistors 411-1, 411-2, 411-3, 411-4, and 411-5, fixed resistors 411-20-1, 411-20-2, 411-20-3, 411-20-4, and 411-20-5, and a DC power source 412A through a power switch 413A. The electrode 409k, as shown in the figure, is connected with the fixed electrodes 409b6 and 409b7 by variable resistors 411-6 and 411-7, fixed resistors 411-21 and 411-22, and a DC power source 412B through a power switch 413B. This embodiment is constructed as mentioned above, and thus when the power switch 413A is closed in a state of FIG. 1, electrostatic attraction is exerted between the lower fixed electrodes 409bl-409b5 and the electrode plate 409k, and the reflecting surface 409a is deformed into a concave shape, together with the substrate 409j and the electrode plate 409k, and acts as a concave mirror. In this case, the variable resistors 411-1 to 411-5 are properly controlled and thereby the concave shape can be adjusted. When the power switch 413B is closed in a state of FIG. 1, electrostatic attraction is exerted between the upper fixed electrodes 409b6-409b11 and the electrode plate 409k, and the reflecting surface 409a, as shown in FIG. 3, is deformed into a convex shape, together with the substrate 409j and the electrode plate 409k, and behaves as a convex mirror. In this case, the variable resistors 411-6 and 411-7 are controlled to apply different voltages to individual electrodes, and thereby the reflecting surface 409a can be deformed into various shapes. Consequently, an effect such that the focal length of the optical system is changed or aberration is altered can be brought about.

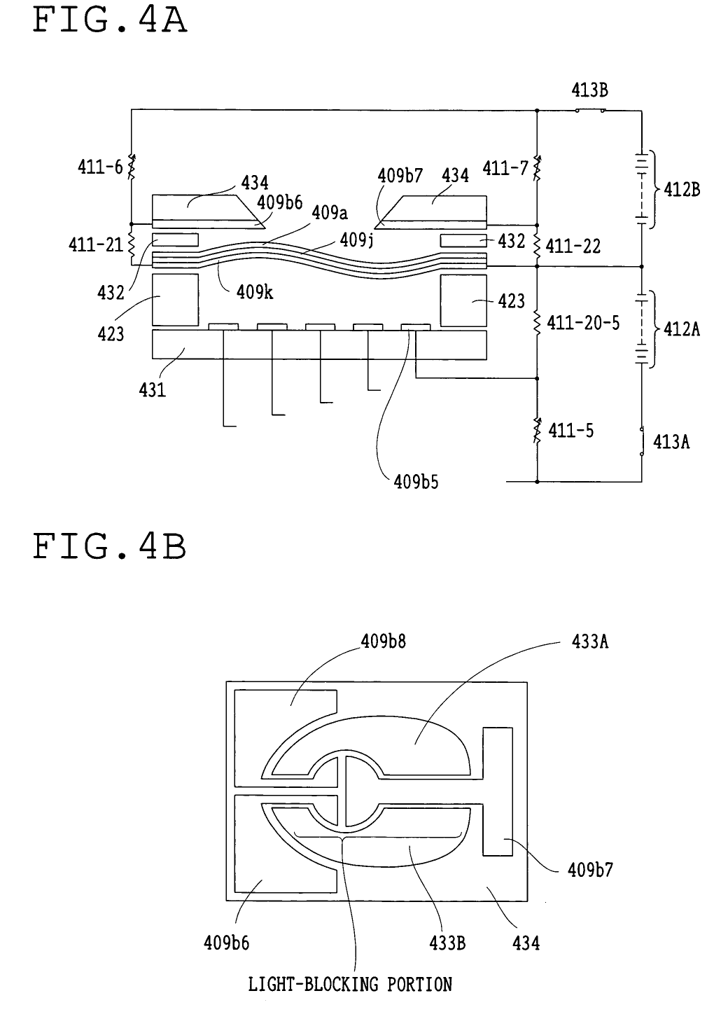

As shown in FIG. 4A, when the power switches 413A and 413B are closed and DC voltages are applied between the electrode plate 409k and the upper electrode 409b6 and between the lower electrode 409b5 and the electrode plate 409k, the left portion of the reflecting surface 409a is pulled upward, while the right portion is pulled downward, so that the reflecting surface 409a can also be deformed into a state where the mirror surface is tilted. Such a surface profile is particularly effective for shake prevention (or shake compensation) of an imaging system or an observing system and compensation for manufacturing errors.

In order to sufficiently increase the electric forces between the electrode plate 409k and the upper electrodes 409b6-409b 11, it is desirable to satisfy the following condition:
0.02≦S₂/S₁≦0.98 (1)
where S₁ is the area of a deformable portion of the substrate 409j (the opening area of the holding frame 432 in FIG. 1) and S₂ is the area of the opening 433. If the value of S₂/S₁ exceeds the upper limit of Condition (1), the electrostatic force will be weakened and the amount of deformation becomes insufficient. Below the lower limit, a utilizable light beam becomes much smaller than the size of the mirror surface, which is unfavorable. In this case, it is further desirable to satisfy the following condition:
0.05≦S₂/S₁≦0.9 (1′)

It is more desirable to satisfy the following condition:
0.08≦S₂/S₁≦0.8 (1″)

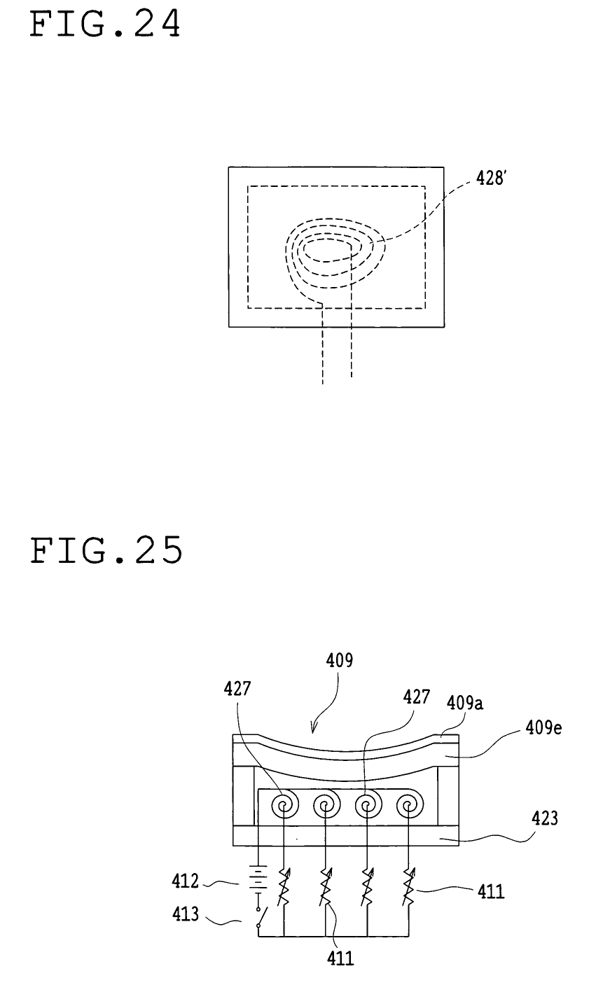

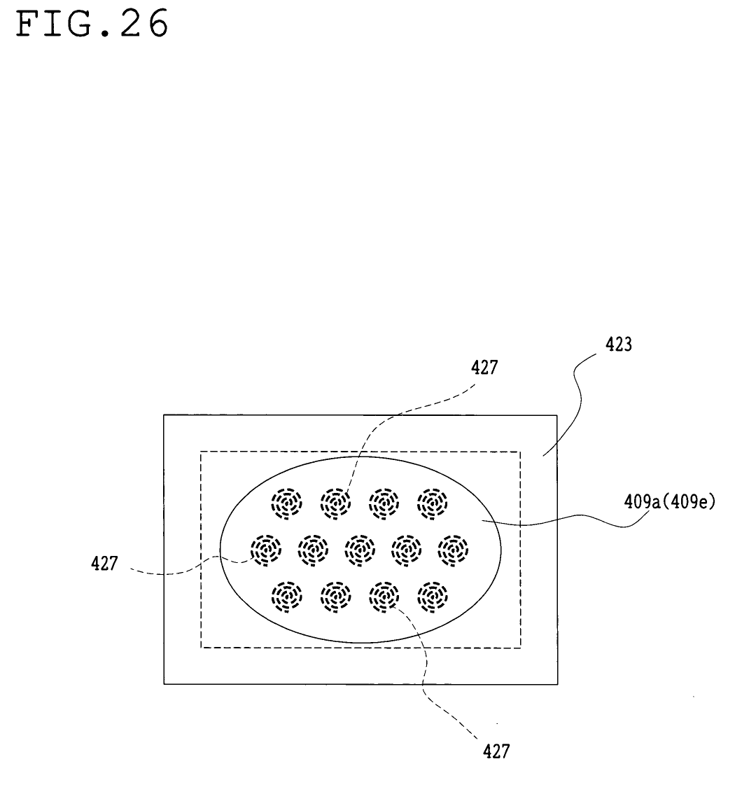

In the above embodiment, the reflecting surface 209a is driven by the electrostatic force and is deformed. However, when the fixed electrodes 409b1-409b11 or the electrode plate 409k, as shown in FIG. 24 or 26 to be described later, is configured as a coil-shaped electrode, the reflecting surface 409a can be deformed by an electromagnetic force. In this case also, Conditions (1), (1′), and (1″) are established.

For example, by increasing the voltage applied between the electrode plate 409k and the fixed electrode 409b6 or 409b7, the reflecting surface 409a may be deformed and used in such a way that it comes in close contact with the fixed electrode 409b6 and 409b7.

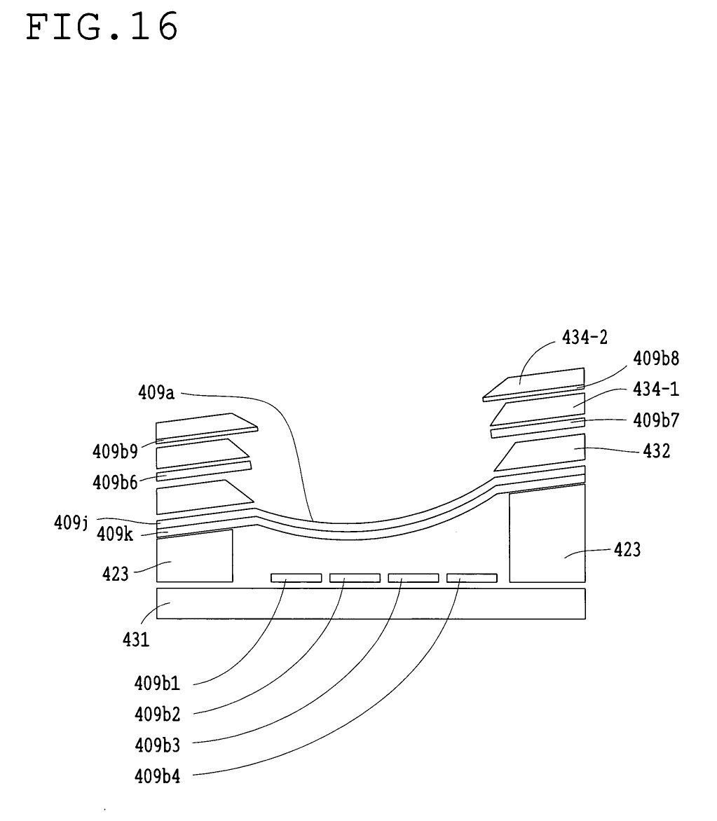

Further, for example, as shown in FIG. 16 to be described later, electrode substrates of a plurality of layers (434-1 and 434-2) may be provided so that the fixed electrodes 409b6-409b9 are arranged on individual electrode substrates 434-1 and 434-2. By doing so, distances between the electrode plate 409k and the fixed electrodes 409b6-409b9 can be variously changed and the number of degrees of deformation freedom can be increased. Alternatively, the upper substrate 434 may be provided with convex and concave parts, on which the divided electrodes are arranged, so that distances between the electrode plate 409k and the divided electrodes are variously changed.

The upper electrodes 409b6-409b9, as illustrated in FIG. 4B, may be provided with a portion blocking a part of the light beam inside the opening 433. In order to provide the upper electrodes as mentioned above, the upper substrate 434 is also designed to partially block the light beam in FIG. 4. Consequently, the opening 433 is divided into two, openings 433A and 433B. By doing so, the reflecting surface 409a can be efficiently deformed into a convex shape.

When the ratio of an area that a light beam to be transmitted is blocked by the upper electrodes (the light-blocking portion in FIG. 4B) to the entire area of the light beam to be transmitted (the sum of the areas of the openings 433A and 433B and the area of the light-blocking portion) is represented by f, it is desirable to satisfy the following condition:
0.001≦f≦0.8 (1A)

Below the lower limit of Condition (1A), the electrostatic force is weakened and thus the number of degrees of deformation freedom is limited. Beyond the upper limit, utilizable light beams are reduced.

It is further desirable to satisfy the following condition:
0.01≦f≦0.5 (1B)

It is more desirable to satisfy the following condition:
0.01≦f≦0.35 (1C)

Also, FIG. 4B illustrates the upper substrate 434 viewed from the lower side of FIG. 1.

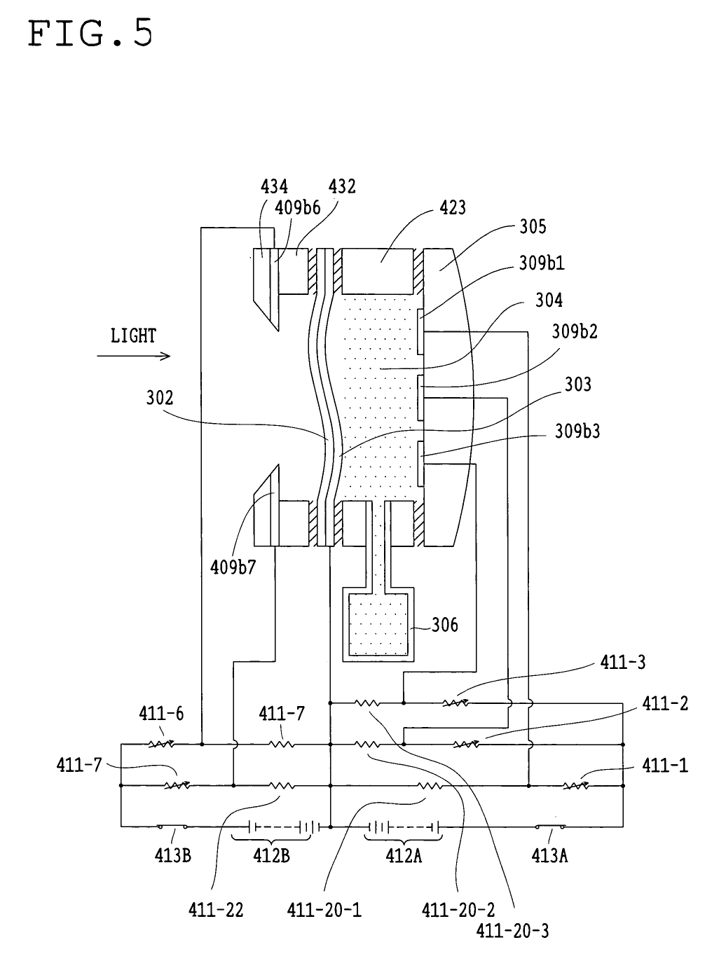

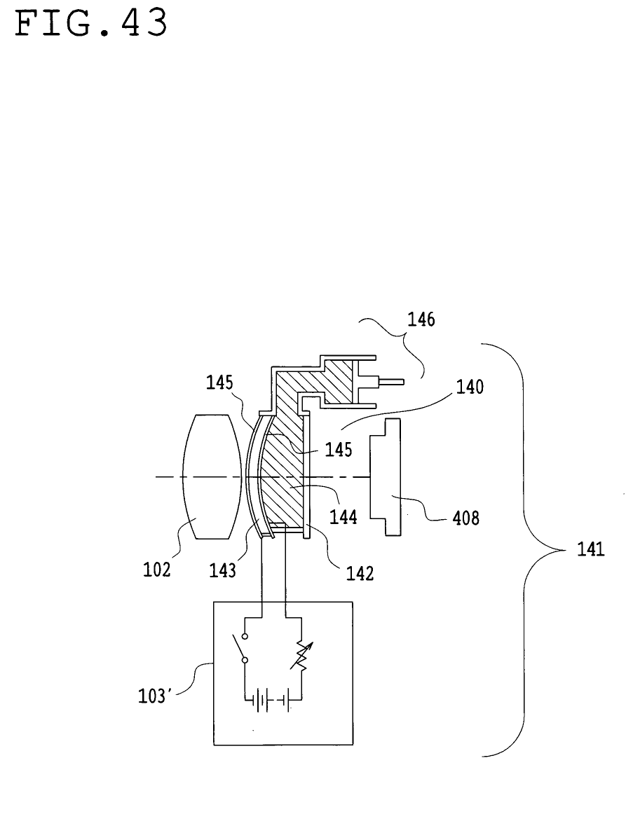

FIG. 5 shows another embodiment of the variable optical-property element according to the present invention. This embodiment is constructed as a variable focal-length lens driven by the electrostatic force and liquid pressure. In the embodiment also, the fundamental structures and arrangement of a transparent deformable film 302; a transparent electrode 303 provided integrally therewith; a transparent substrate 305 which may have the shape of a lens provided with transparent fixed electrodes 309b1, 309b2, and 309b3; the fixed electrodes 409b6 and 409b7; and the fixed substrate 434 are the same as in the embodiment already mentioned. The supporting base 423, as well as the transparent electrode 303 and the transparent substrate 305, comes into close contact with a liquid, and a chamber provided between the transparent electrode 303 and the transparent substrate 305 is charged with a transparent liquid 304. A liquid tank 306 communicating with the chamber of the transparent liquid 304 is mounted to the side wall of the supporting base 423. The liquid tank 306 may be replaced with a cylinder 146 shown in FIG. 43 to be described later. The transparent liquid 304 is pressurized by the cylinder 146 and thereby the film 302 may be deformed into a convex shape. When negative pressure is applied to the transparent liquid 304, the film 302 can also be deformed into a concave shape. The film 304 may be driven by combining the liquid pressure with the electric force.

Also, the configuration of the DC power sources, variable resistors, fixed resistors, and power switches, connected between individual electrodes, is substantially the same as in the embodiment of FIG. 1 and thus like numerals are used for these elements.

This embodiment is constructed as mentioned above, and therefore, as in the embodiment of FIG. 1, for example, when DC voltages are applied between the transparent electrode 303 and the fixed electrodes 309b6 and 309b7, the transparent film 302 is pulled leftward together with the transparent electrode 303. Moreover, when various voltages are applied between the transparent electrode 303 and the fixed electrodes 309b1-309b3 or between the transparent electrode 303 and the fixed electrodes 309b5 and 309b6, the transparent film 302 can be deformed into various shapes. In this way, the lens of the embodiment can be designed to function as the variable focal-length lens or a variable aberration lens. In addition, like a variable angle prism, the function of changing the deflection angle of light can be provided.

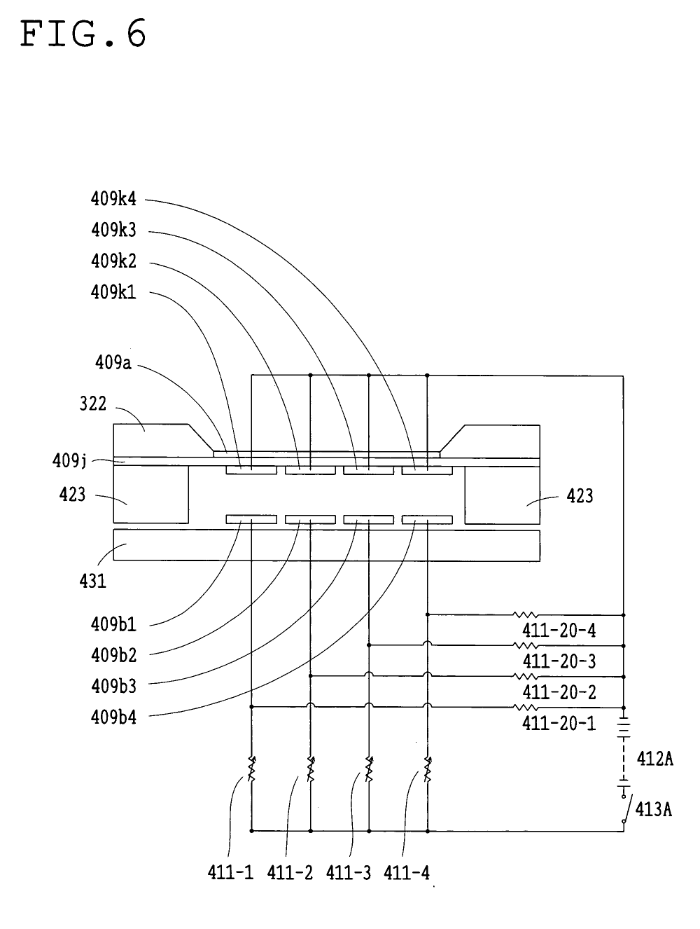

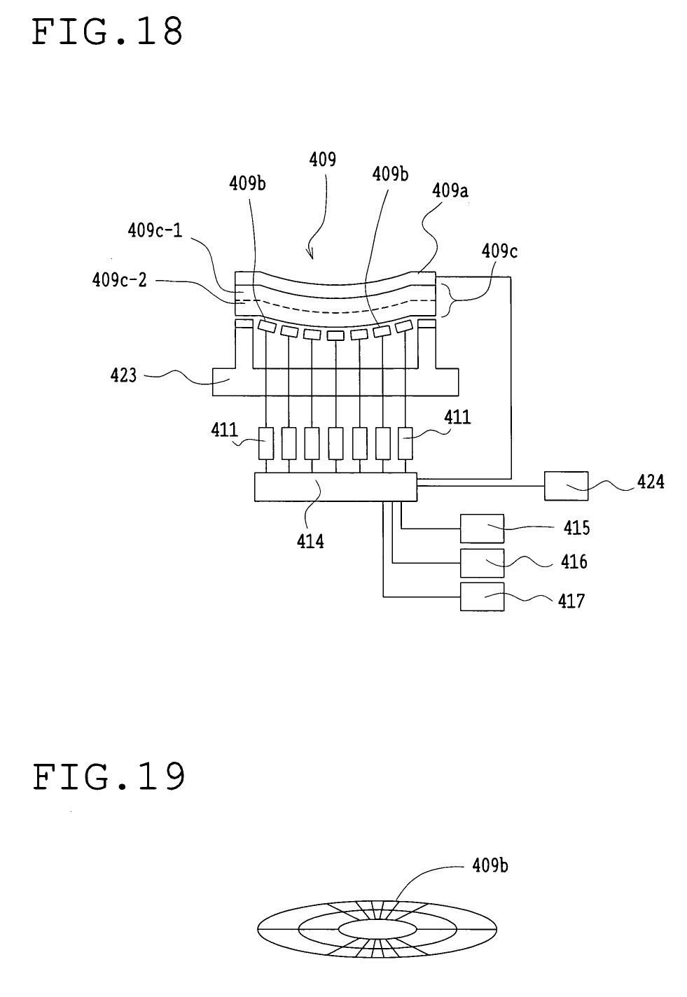

FIG. 6 shows still another embodiment of the variable optical-property element according to the present invention. This embodiment is constructed as a deformable mirror drived by the electrostatic force in which the divided, fixed electrodes 409b1-409b4 are provided on the lower substrate 432, and divided, deformable electrodes 409k1, 409k2, 409k3, and 409k4 are also provided on the substrate 409j. As shown in this figure, when potentials of the electrodes 409k1-409k4 are rendered the same or identical signs, the variable optical-property element, as in the example of FIG. 18 described later, behaves as the deformable mirror deformed into a concave shape by the electrostatic force. Also, although in this embodiment reference numeral 322 denotes an upper substrate, like numerals are used for substantially like elements with respect to the above embodiments and their explanation is omitted. In order to deform the mirror into a concave shape, it is only necessary that the reflecting surface 409a is used as the electrode instead of the electrodes 409k1-409k4 so that voltages or currents are applied between the reflecting surface 409a and the electrodes 409k1-409k4.

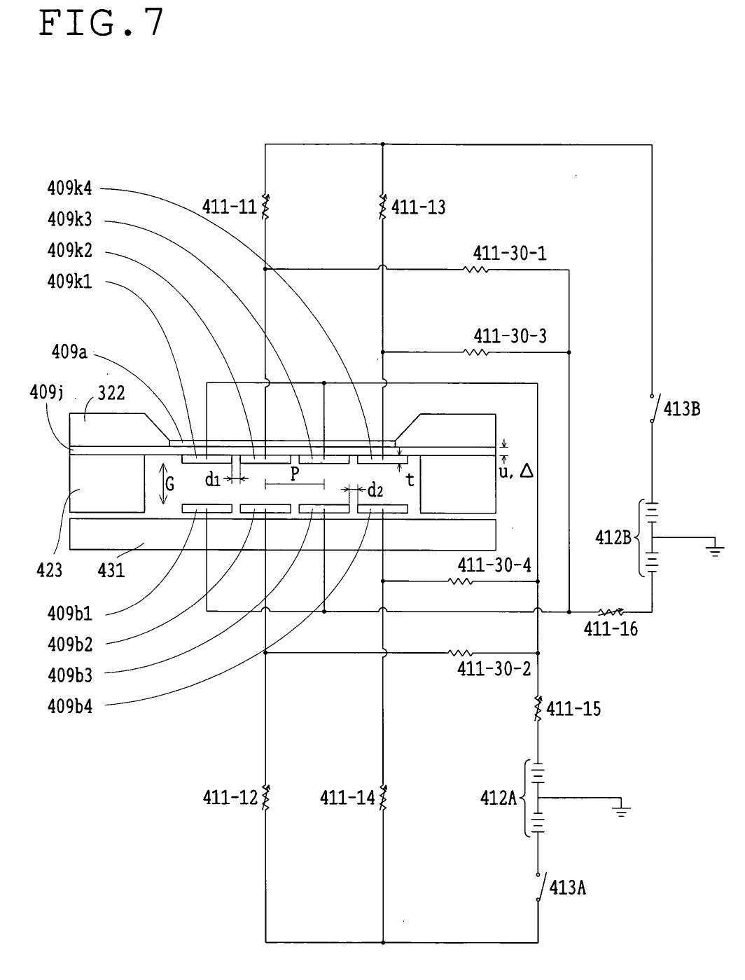

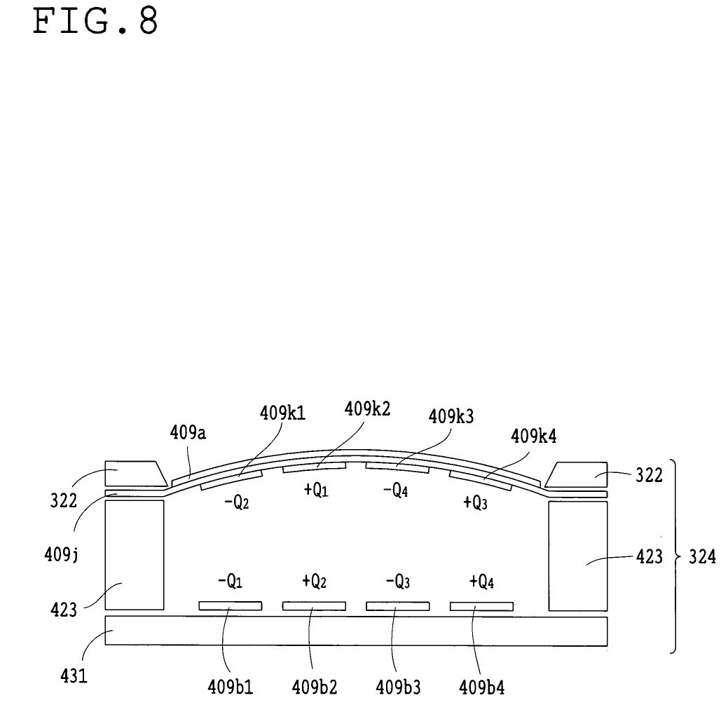

On the other hand, when a driving circuit applying voltages is used as shown in FIG. 7 and the power switches 413A and 413B are closed, the deformable mirror 409a, as shown in FIG. 8, is deformed, together with the substrate 409j, into a convex shape. This is because, as shown in FIG. 8, electric charges −Q₂, +Q₁, −Q₄, and +Q₃ are produced in the upper electrodes 409k1-409k4, respectively, and electric charges −Q₁, +Q₂, −Q₃, and +Q₄ are produced in the fixed electrodes 409b1-409b4, respectively, so that electrostatic forces of repulsion are exerted between opposite electrodes.

Also, in FIG. 7, reference numerals 411-11, 411-12, 411-13, 411-14, 411-15, and 411-16 denote variable resistors, and 411-30-1, 411-30-2, 411-30-3, and 411-30-4 denote fixed resistors. Like numerals are used for substantially like elements with respect to the above embodiments and their explanation is omitted.

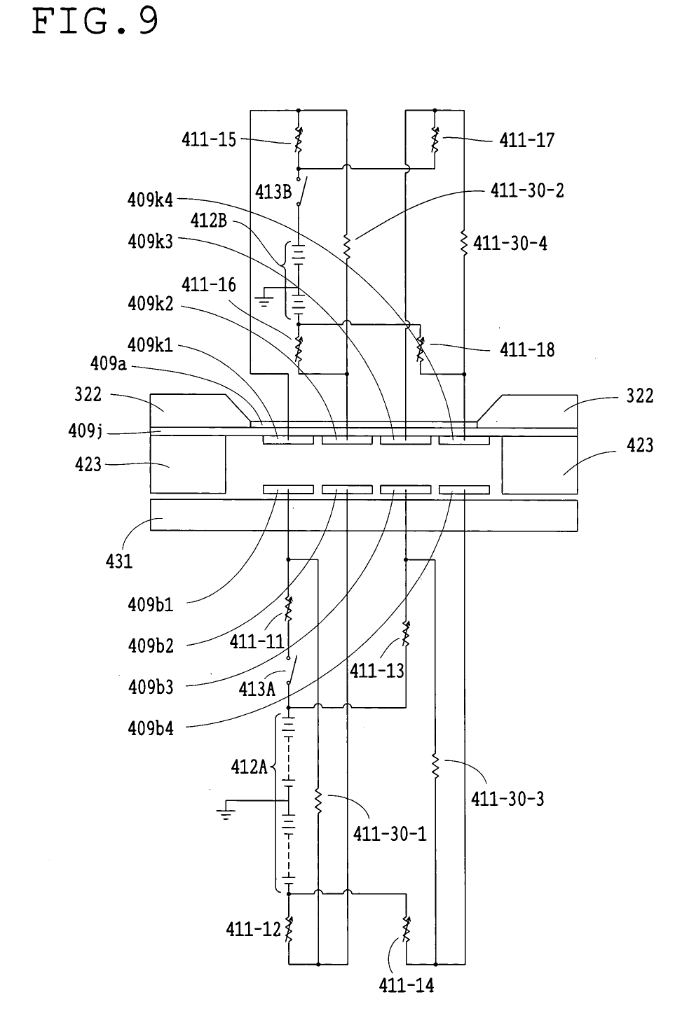

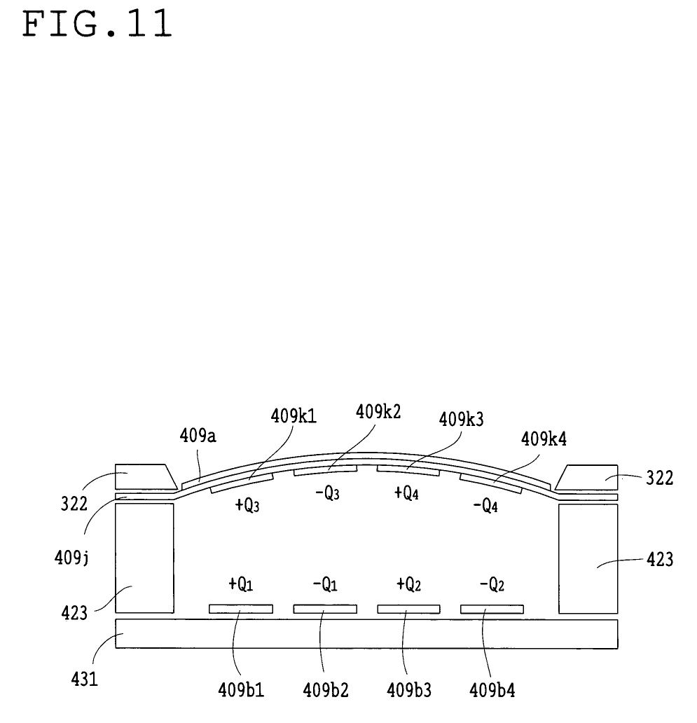

The driving circuit shown in FIG. 9 may be designed so that voltages are applied to individual electrodes. In this driving circuit, when the power switched 413A and 413B are closed, as shown in FIG. 11, the electric charges are stored in individual electrodes 409b1-409b4 and 409k1-409k4 and thus the electric forces of repulsion are exerted between opposite electrodes to deform the reflecting surface 409a into a convex shape.

Also, although in FIG. 9 reference numerals 411-17 and 411-18 denote variable resistors, like numerals are used for substantially like elements with respect to the above embodiments and their explanation is omitted. At least one of the electrodes 409k1-409k4 or 409b1-409b4 may be subdivided into a plurality of segments so that the voltages of identical signs are applied to the electrodes of these segments.

As will be obvious from the above discussion, in the driving circuit of FIG. 7 or 9, the resistance values of the fixed resistors or the variable resistors are changed and thereby the profile of the reflecting surface 409a can be variously altered.

In this embodiment, in order to set the substrate 409j to the convex surface of strong power, it is necessary to increase the electrostatic force of repulsion. For this, as shown in FIG. 7, when a distance between the upper electrodes 409k1-409k4 and the lower electrodes 409b1-409b4 where the substrate 409j is flat is represented by G (when the surfaces of the electrodes are rough and the distance G varies with the electrodes, it is assumed that the average value of the distances G is used) and average center-to-center spacing between adjacent electrodes is represented by P, it is desirable to satisfy the following condition:
1/1000000<G/P<300 (2)

If the value of G/P exceeds the upper limit of Condition (2), a repulsive force between a certain electrode and an electrode opposite thereto will be canceled by an attractive force between the electrode and an electrode adjacent thereto so that the substrate 409j is not virtually deformed. Below the lower limit, the value of the distance G becomes too small and the fabrication of the variable mirror itself is difficult. In this case, it is further desirable to satisfy the following condition:
1/100000<G/P<100 (2′)

When d denotes an average distance of spacing between adjacent electrodes (in FIG. 7, d, denotes the average value of the distance of spacing between the electrodes 409k1 and 4092, the distance of spacing between the electrodes 409k2 and 409k3, . . . , and d₂ denotes the average value of the distance of spacing between the electrodes 409b1 and 409b2, the distance of spacing between the electrodes 409b2 and 409b3, . . . ), it is desirable to satisfy the following condition:
1/1000000<G/d<1000 (3)

Beyond the upper limit of Condition (3), a repulsive force between a certain electrode and an electrode opposite thereto is canceled by an attractive force between the electrode and an electrode adjacent thereto so that the substrate 409j is not virtually deformed. Below the lower limit, the value of the distance G becomes too small and the fabrication of the variable mirror itself is difficult. In this case, it is further desirable to satisfy the following condition:
1/100000<G/d<300 (3′)

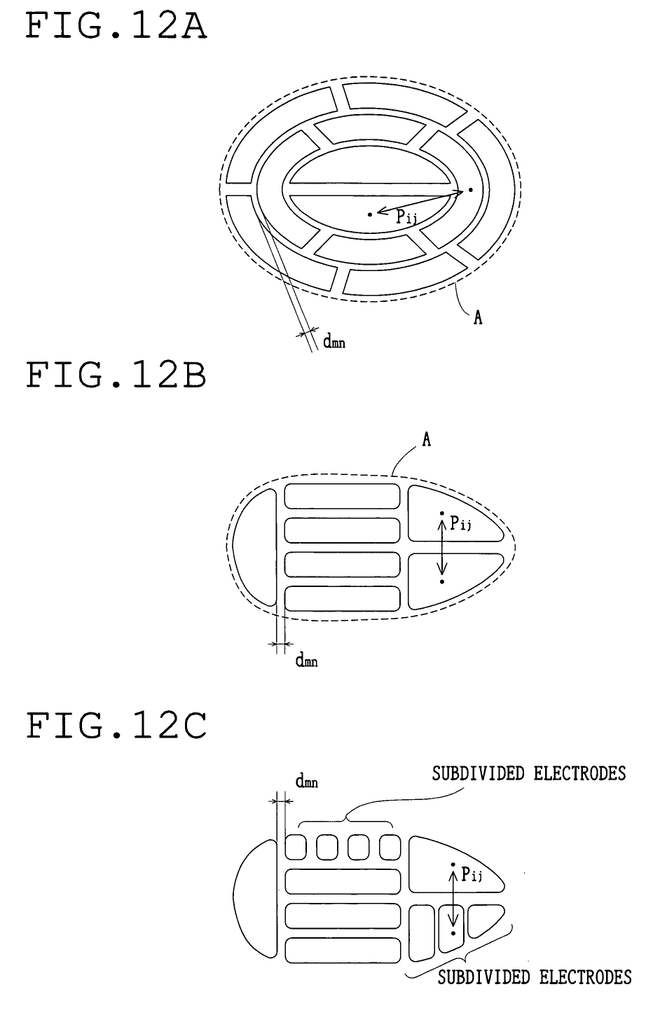

When the sum of areas of electrodes divided and arranged on one substrate is represented by a and the area of the entire electrode region of the substrate (the area of the electrode region surrounded by a dotted line in FIG. 12A) is represented by A, it is desirable to satisfy the following condition:
0.001<a/A<1 (4)

Below the lower limit of Condition (4), the amount of electric charges stored in the electrodes is decreased and the electric force is weakened. In this case, it is further desirable to satisfy the following condition:
0.01<a/A<1 (4′)

Also, although in FIG. 9 the voltages are applied to the lower electrodes 409b1-409b4 as well, the voltages may be applied to only the upper electrodes 409k1-409k4. In this case also, as shown in FIG. 11, electric charges +Q₃, −Q₃, +Q₄, and −Q₄ are stored, and thus electrostatic attraction is exerted between the upper electrodes 409k1 and 409k2, between the upper electrodes 409k2 and 409k3, and between the upper electrodes 409k3 and 409k4 so that the substrate 409j is warped upward. The voltages may be applied across the these electrodes so that forces exerted between the electrodes are repulsion. Such an approach is also applicable to the variable focal-length lens. In addition, the electrodes may be replaced with coils so that forces are generated between the electrodes by electromagnetic forces to deform the reflecting surface 409a. It is assumed that electrostatic forces and electromagnetic forces are generally called electric forces.

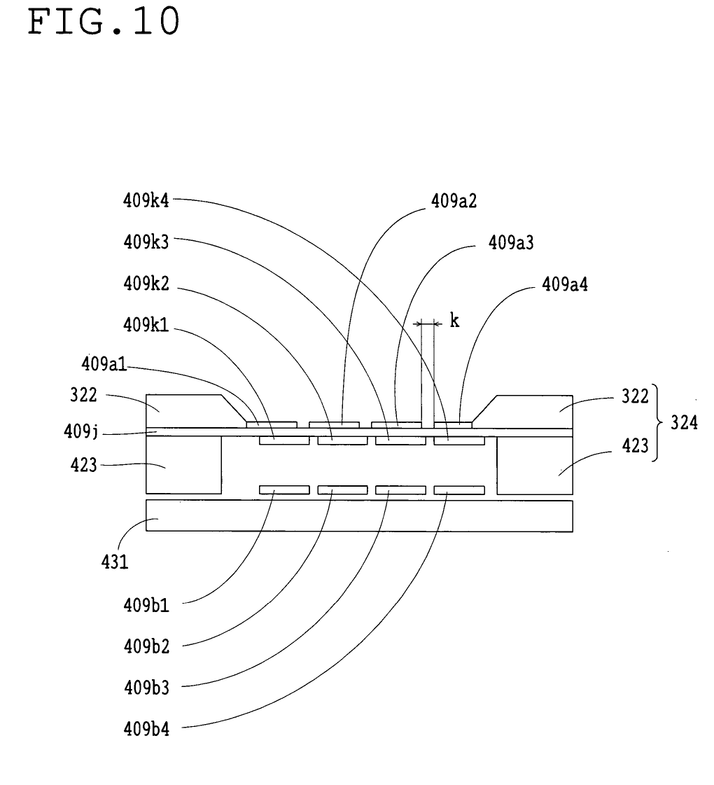

FIG. 10 shows one embodiment of the variable mirror. The description of this embodiment will be given later.

FIGS. 12A, 12B, and 12C show examples of division patterns of the upper electrodes 409k1-409k4 or the lower electrodes 409b1-409b4, used in the variable mirror. In these figures, subscripts i, j, m, and n indicate natural numbers, which are the numbers assigned to the electrodes, Pij indicates a distance between centers of gravity of the i-th and j-th electrodes, P indicates the average value of the distances Pij, dmn indicates the distance of spacing between the m-th and n-th electrodes, and d indicates the average value of the distances dmn.

When the areas of individual divided electrodes are nearly equal, the control of the profile of the reflecting surface 409a is facilitated. For the value of the distance P, it is only necessary to use the average value of the distances Pij between centers of gravity of figures of individual electrodes. The configuration or the number of the upper electrodes need not necessarily coincide with the configuration or the number of the lower electrodes. When any of the upper electrodes 409k1-409k4 and the lower electrodes 409b1-409b4 is subdivided and the voltages of identical signs are applied to these subdivided electrodes, it is assumed that the distances P and d where the subdivided electrodes are regarded as one electrode are adopted. This consideration also holds for electrodes in embodiments to be described below. This state is shown in FIG. 12C. The electrodes before subdivision are shown in FIG. 12B.

Reference has been made to the variable mirror as another embodiment, but by providing the structure similar to that of FIG. 5, it can be applied as the variable focal-length lens. In this case, it is merely necessary that the transparent electrode 303 in FIG. 5 is divided into a plurality of segments and as shown in FIG. 6, 7, or 9, voltages are applied between these segments and the transparent electrodes 309b1-309b3. Whereby, the transparent film 302 can be deformed into either a concave or convex shape. In this case, the fixed electrodes 409b6 and 409b7 are unnecessary.

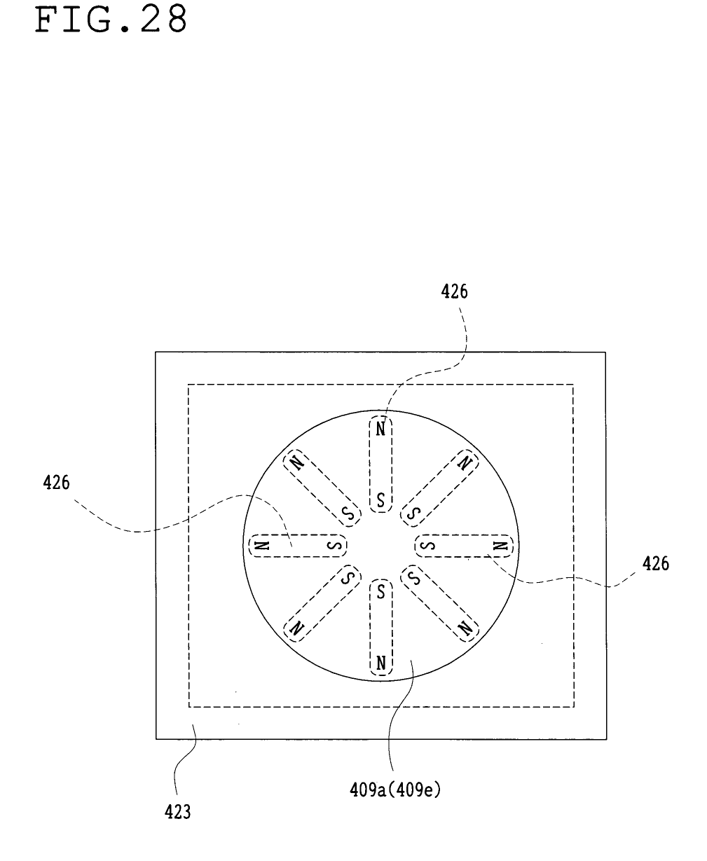

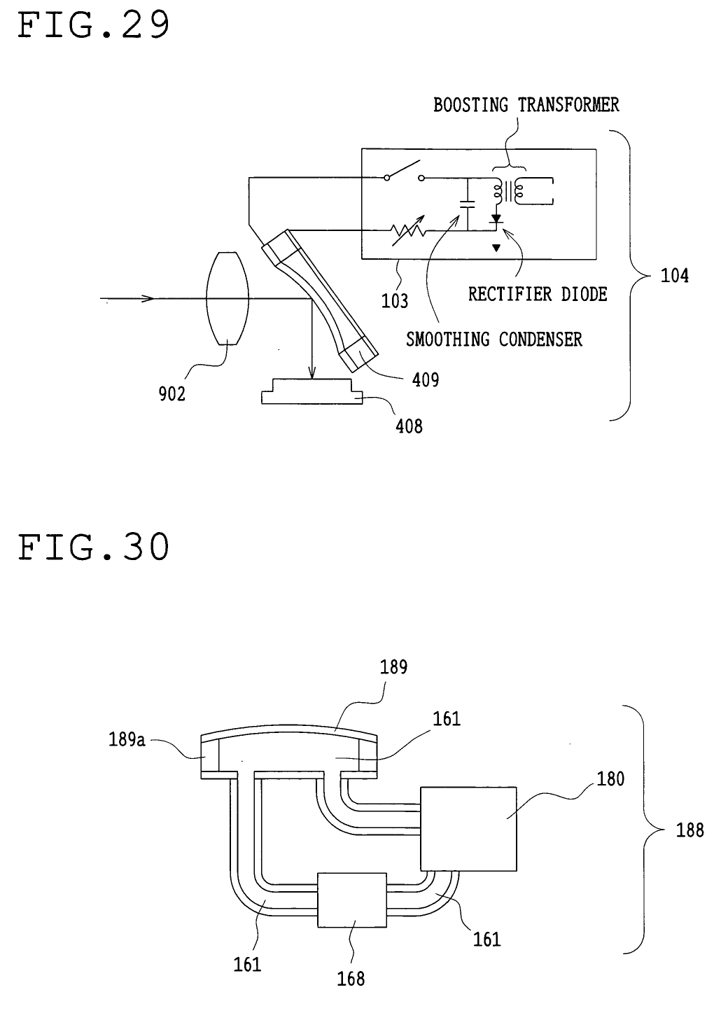

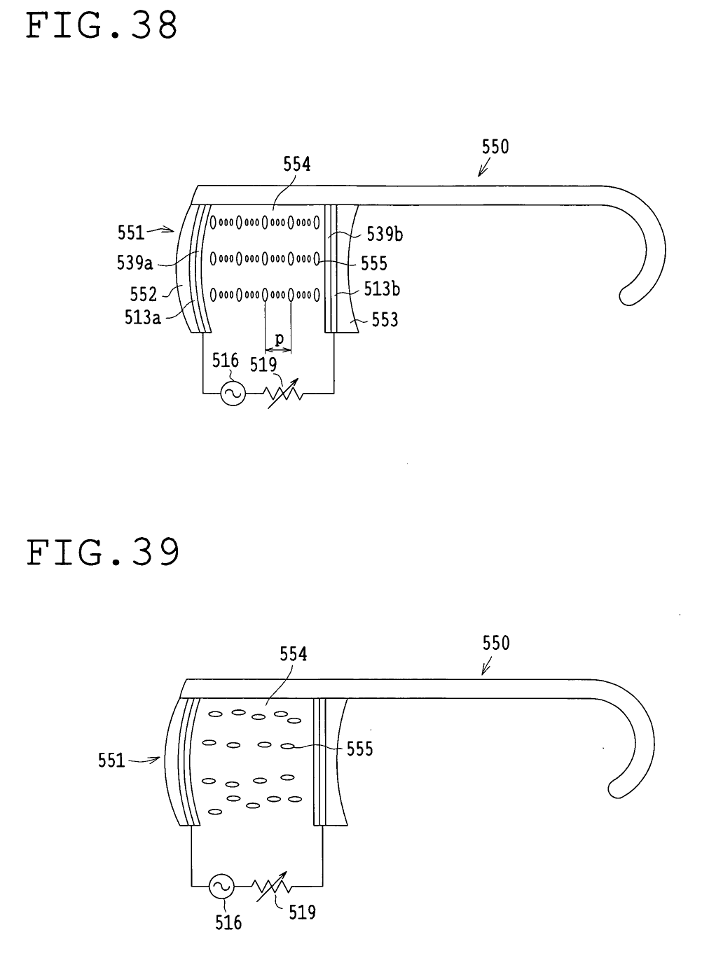

In the disclosure so far, the DC power sources 412A and 412B have been used as the power sources in any of the embodiments, but AC power sources may be used. Even in the case of the AC power source, when an AC frequency is sufficiently high, the optical surface assumes almost the same shape by keeping the voltage constant. Consequently, this variable optical-property element can be used in the optical apparatus, such as an imaging apparatus of FIG. 29 or 36, or an observing apparatus of FIG. 38 to be described later.

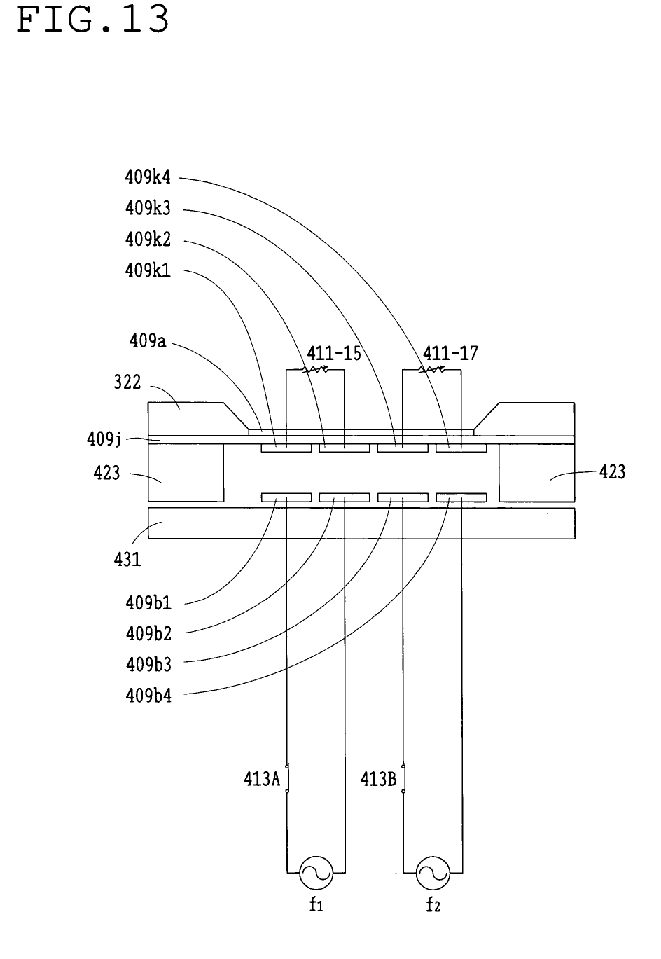

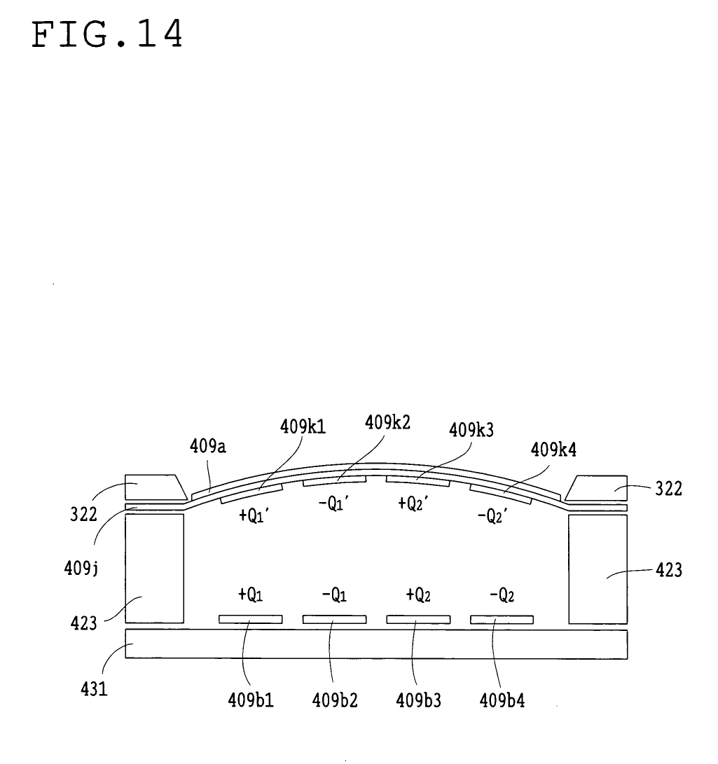

FIG. 13 shows another driving technique of the variable mirror in still another embodiment. In this example, when the AC voltage with a low frequency f, is applied across the lower electrodes 409b1 and 409b2, the electric charges of signs opposite to those of the electrodes 409b1 and 409b2 are produced in the electrodes 409k1 and 409k2 facing these lower electrodes (refer to FIG. 14). As such, the substrate 409j is pulled downward by electrostatic attraction. Then, when the frequency of the AC voltage is increased, a time lag occurs due to the resistance value of a variable resistor 411-15 until the electric charges of signs opposite to those of the electrodes 409b1 and 409b2 are produced in the electrodes 409k1 and 409k2. Thus, there is a time that the electric charges of identical signs are produced in the lower electrode 409b1 and the upper electrode 409k1, and during this time, the repulsion is exerted between these two electrodes. When the resistance value of the variable resistor 411-15 is increased, the time lag is also increased and the repulsion is exerted between the two electrodes. In this way, the frequency f, of the AC voltage or the resistance value of the variable resistor 411-15 is changed, and thereby the force exerted between the two electrodes can be rendered either the attraction or the repulsion.

The above description also holds for the relationship between the lower electrodes 409b3 and 409b4 and the upper electrodes 409k3 and 409k4. According to this construction, there is the advantage that the electronic circuit for the upper electrodes 409k1-409k4 is simplified, compared with other examples already mentioned.

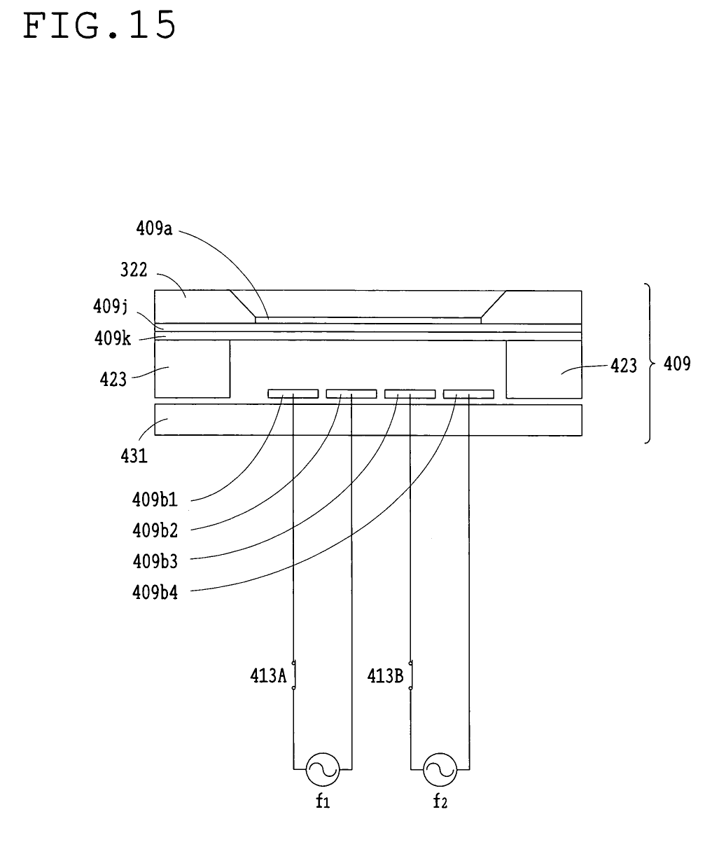

As shown in FIG. 15, the upper electrode 409k, which is not divided, is constructed as a single electrode made from a high-resistant material. When AC voltages are applied between the lower electrodes 409b1 and 409b2 and between the lower electrodes 4093 and 4094, the force applied to the upper electrode 409k is changed from the attraction to the repulsion as frequencies f₁ and f₂ are increased. In this case, there is the advantage that the structure of the upper electrode is simplified. Also, the mirror may be designed so that the lower electrodes 409b1-409b4 are not divided and is made from a high-resistant material, while the upper electrode is divided and AC voltages are applied to divided electrodes.

The upper electrode 409k may also be substituted by the thin film 409a. In this case, there is the advantage that the structure of the thin film is simplified.

Conditions (2), (2′), (3), (3′), (4), and (4′) are also established in the cases of the above two examples for similar reasons.

In each of FIGS. 13 and 15, the variable mirror is cited as an example, but the above driving technique is also applicable to the variable focal-length lens. In this case, it is merely necessary that in FIG. 5, the transparent electrode 303 is thought of as the upper electrode 409k or the electrodes 409k1-409k4, and AC voltages are applied across the electrodes 409k1-409k4 and the fixed electrodes 309b1-309b3.

In the example of each of FIGS. 6, 7, 9, 13, and 15, except for the upper electrodes 409k1-409k4 of FIG. 13, voltages are applied to all divided electrodes, but the voltages may not be applied to some electrodes. By selecting electrodes to which voltages are applied, the number of degrees of deformation freedom of the substrate 409j is increased. In particular, this may offer the advantage when an attempt is made to produce the repulsion between the upper and lower electrodes.

When the division pattern of the electrode is designed to have the same symmetrical surface as the optical system using the deformable mirror and to reduce the area of the electrode in going from the center to the periphery, control is facilitated. The electrodes shown in FIGS. 12A and 12B are constructed as mentioned above.

Also, in order to compensate for the fabrication error of the optical system, it is desirable that voltages applied to electrodes is capable of having an asymmetrical pattern with respect to the symmetrical surface.

In the embodiments of the variable optical-property elements described above, the electrodes arranged on the substrate are parallel when the substrate is not deformed, but they need not necessarily be parallel. Specifically, as shown in FIG. 16, the electrode may be tilted. When the variable optical-property element is constructed in this way, there is the advantage that voltages applied between the upper and lower electrodes are not considerably changed and the asymmetrical configuration of the optical surface is obtained.

In this embodiment, as shown in FIG. 16, the upper substrate 434 of FIG. 1 is divided into a first upper substrate 434-1 and a second upper electrode 434-2 so that the first upper substrate 434-1 is provided with the electrodes 409b6 and 409b7 and the second upper substrate 434-2 is provided with the electrodes 409b8 and 409b9.

Also, in the embodiment, the upper electrodes 409b6-409b9, the holding frame 432, the first upper substrate 434-1, and the second upper substrate 434-2 may be eliminated.

The surface of each of the lower substrate 431 and the upper substrate 434-1 or 434-2 may have not a flat shape, but a curved shape.

The variable optical-property element according to the present invention in any of the embodiments mentioned above is used for focusing, diopter adjustment, magnification change, shake compensation, compensation for fabrication errors, compensation for temperature and humidity changes, and compensation for changes with age in the optical apparatus. The structures of such optical apparatuses are shown in FIGS. 29, 36, 38, and 43 to be described later.

In the embodiments in FIG. 6 and the figures thereafter, when electrodes are constructed as transparent electrodes, the deformation techniques of the optical surfaces in the embodiments can be also used for the variable focal-length lens.

In each of the embodiments of FIGS. 6, 7, 9, 10, and 13, when the thickness (or the width in the vertical direction on the plane of the page) of each of the upper electrodes 409k2-409k4 and the lower electrodes 409b1-409b4 is denoted by t and its area is denoted by w, it is desirable to satisfy the following condition:
0.000001≦t/\sqrt{w}≦10000 (5)

Below the lower limit of Condition (5), the electric field of an electrode periphery becomes so strong that electric discharge occurs. Beyond the upper limit, the electrodes become too thick and the thickness of the deformable mirror or the variable focal-length lens is increased. It is further desirable to satisfy the following condition:
0.00001<t/\sqrt{w}≦1000 (5′)

In each of the embodiments of FIGS. 6, 7, 9, 10, and 13, when the thickness of the substrate 409j is denoted by u, it is desirable to satisfy the following condition:
0.0000001≦u/G≦1000 (6)

Below the lower limit of Condition (6), the electrostatic force is weakened due to inductive charges produced in the thin film 409a. Beyond the upper limit, the rigidity of the substrate 409j is increased and the deformation becomes difficult. It is further desirable to satisfy the following condition:
0.000001≦u/G≦100 (6′)

Alternatively, when a distance between the thin film 409a and the upper electrodes 409k1-409k4 is denoted by A, it is desirable to satisfy the following condition:
0.0000001≦Δ/G≦1000 (7)

Below the lower limit of Condition (7), the electrostatic force is weakened due to inductive charges produced in the thin film 409a. Beyond the upper limit, the rigidity of the substrate 409j is increased and the deformation becomes difficult. It is further desirable to satisfy the following condition:
0.000001≦Δ/G≦100 (7′)

In each of the embodiments of FIGS. 6, 7, 9, 10, and 13, to obviate the disadvantage that the electrostatic force is weakened due to the inductive charges produced in the thin film 409a, the thin film 409a, as shown in FIG. 10, may be divided in accordance with the upper electrodes 409k1-409k4 opposite thereto. Reference numerals 409a1-409a4 stand for divided reflecting films, which are roughly similar in shape to the upper electrodes 409k1-409k4, respectively. The number of the reflecting films 409a1-409a4 need not necessarily coincide with that of the upper electrodes 409k1-409k4, and their shapes need not be exactly similar. It is only necessary to obviate the disadvantage of reducing the electrostatic force. When a distance k between the divided reflecting films is expressed in millimeters (mm), it is desirable to satisfy the following condition:
0.00001<k<100 (8)

Below the lower limit of Condition (8), the fabrication of the thin film 409a becomes difficult. Beyond the upper limit, the area of the reflecting film is reduced and the amount of light is lost. It is further desirable to satisfy the following condition:
0.0001<k<20 (8′)

In the present invention, apart from the variable optical-property element itself, a combination of the variable optical-property element with its driving circuit is sometimes called the variable optical-property element.

In FIG. 10, the divided reflecting films 409a1, 409a2, 409a3, and 409a4 may be used as the divided electrodes instead of the upper electrodes 409k1, 409k2, 409k3, and 409k4. In this case, the upper electrodes 409k1, 409k2, . . . may be eliminated, and in such an instance, since the rigidity of a deformed portion is reduced, the deformation is facilitated. Similarly, in FIGS. 6-9 and FIG. 11, 13, and 14, the thin film 409a may be divided into a plurality of segments and used as the divided electrodes. By doing so, an effect similar to the case of FIG. 10 is brought about.

Also, even when the upper electrodes 409k1, 409k2, . . . remain as they are and the thin film 409a is merely divided, the rigidity of the deformed portion is reduced and thus the deformation is facilitated.

Even in the variable mirror such as that shown in FIG. 42 in which the substrate or the optical surface is not deformed, the reflecting surface may be divided and used as the divided electrodes.

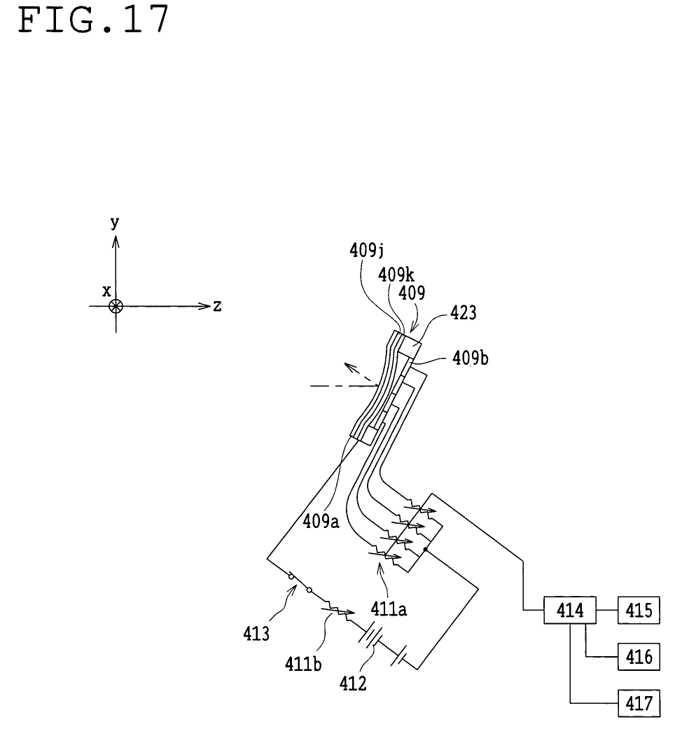

In the variable optical-property element such as the variable mirror or the variable focal-length lens, when the optical surface is deformed into a convex shape, a fluid may be used as in FIG. 30, while when it is deformed into a concave shape, the electric force, such as the electrostatic force, electromagnetic force, or piezoelectric effect, may be used as in FIG. 17, 18, or 23.

In the deformation into either the concave or convex shape, the force of the fluid may be combined with the electric force. By combining a plurality of forces, the variable optical-property element whose surface can be deformed into various shapes is obtained. At least two electric forces may, of course, be combined.

For example, it is assumed that, in the imaging system using the variable mirror such as that in FIG. 29, when the optical surface is deformed into a convex shape, the pressure of the fluid is used, while when it is deformed into a concave shape, the electrostatic force is used. When the profile of the reflecting surface is flat, an image sensor 408 is positioned so that the focus is taken at a distance where the far point of the depth of field becomes infinite.

In an autofocus operation for photography, the variable mirror is deformed in the range from the convex surface to the concave surface and at the same time, photography is performed through the image sensor 408. It is only necessary to judge that the focus is taken when a high-frequency component of an image of an object is maximized. When actual photography is performed with the profile of the reflecting surface of the variable mirror in that case, a good image is obtained. Even when the reflecting surface of the variable mirror can be deformed into only a flat shape because of power failure or the trouble of the driving circuit, a nearly far point is brought to a focus and thus any problem is hard to arise in practical use.

When the reflecting surface is flat, the image sensor 408 may be positioned by choosing any object distance for focus between the infinity and 0.5 meters. When the image sensor 408 is positioned in this way, a similar effect is obtained in case of power failure.

The technique of the focusing operation mentioned above is also applicable to the variable focal-length lens and is, of course, applicable to the variable mirror or the variable focal-length lens which uses one kind of driving force.

In the variable optical-property element constructed so that the optical surface is deformed into a convex shape by means of the fluid and then into a concave shape by means of the electrostatic force, it is good practice to provide the variable mirror or the variable focal-length lens with a fluid-discharge valve.

Subsequently, reference is made to other various structural examples of variable optical-property elements in the present invention and examples of optical apparatuses using the variable optical-property elements.

In FIG. 17, the deformable mirror 409 includes the thin film (reflecting surface) 409a of an aluminum coating formed on the deforming substrate 409j; the plurality of electrodes 409b in which the periphery of the three-layer structure including the electrode 409k provided beneath the substrate 409j is supported by the annular support 423 so that the electrodes 409b are spaced away from the electrode 409k and are mounted to the support 423; a plurality of variable resistors 411a connecting to the electrodes 409b and functioning as driving circuits; a power source 412 connected between the electrode 409k and the electrodes 409b through a variable resistor 411b and a power switch 413; and an arithmetical unit 414 for controlling the resistance values of the plurality of variable resistors 411a. A temperature sensor 415, a humidity sensor 416, and a range sensor 417 are connected to the arithmetical unit 414, and as shown in the figure, these constitute one optical unit. Also, the deforming substrate 409j may be the thin film or a plate.

The reflecting surface of the variable mirror need not necessarily be planar, depending on the control of the arithmetical unit 414, and may have any shape such as a spherical or rotationally symmetrical aspherical surface; a spherical, planar, or rotationally symmetrical aspherical surface which has decentration with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. In general, such a surface is referred as to an extended surface. By the reflecting surface constructed of the thin film 409a, a ray of light is reflected in the direction of the arrow of the figure.

The thin film 409a, like a membrane mirror set forth, for example, in “Handbook of Microlithography, Micromachining and Microfabrication”, by P. Rai-Choudhury, Volume 2: Micromachining and Microfabrication, p. 495, FIG. 8.58, SPIE PRESS, or Optics Communication, Vol. 140, pp. 187-190, 1997, is such that when voltages are applied between the plurality of electrodes 409b and the electrode 409k, the thin film 409a is deformed by the electrostatic force and its surface profile is changed.

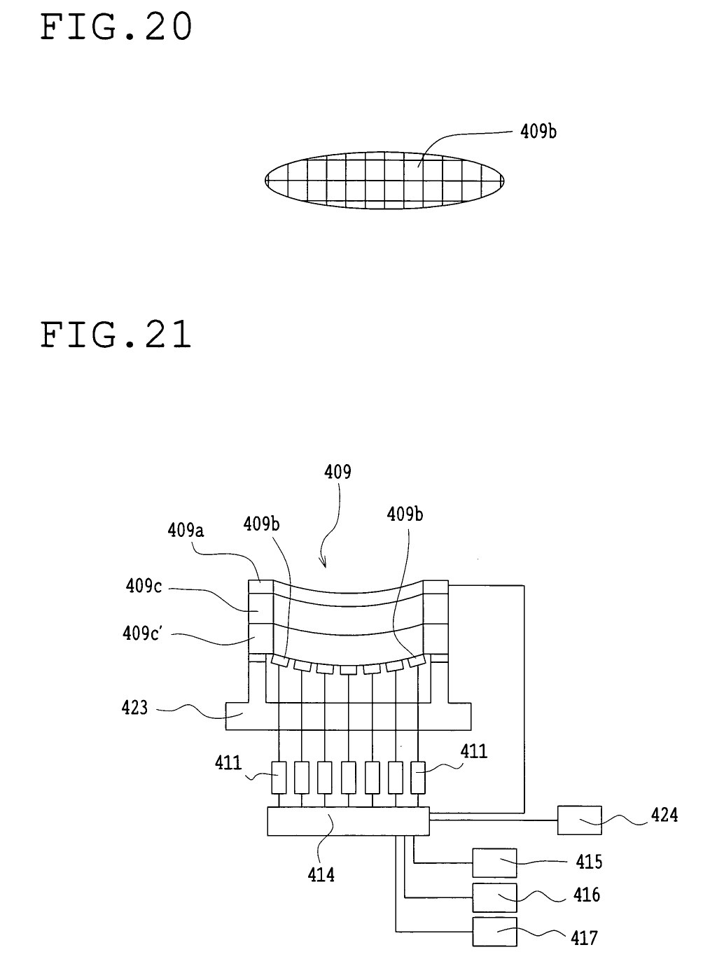

Also, it is only necessary that the profile of the electrodes 409b, for example, as shown in FIG. 19 or 20, is selected to have a concentric or rectangular division pattern in accordance with the deformation of the thin film 409a.

As mentioned above, the configuration of the thin film 409a functioning as the reflecting surface is controlled in such a way that the resistance values of the variable resistors 411a are changed by signals from the arithmetical unit 414 to optimize imaging performance. Signals corresponding to ambient temperature and humidity and a distance to the object are input into the arithmetical unit 414 from the temperature sensor 415, the humidity sensor 416, and the range sensor 417. In accordance with these input signals, the arithmetical unit 414 outputs signals for determining the resistance values of the variable resistors 411a so that voltages governing the configuration of the thin film 409a are applied to the electrodes 409b by the command of an image processor for the ambient temperature and humidity conditions and the distance to the object or the electronic zoom. Thus, since the thin film 409a is deformed with the voltages applied to the electrodes 409b, that is, the electrostatic forces, it assumes the shapes of various extended surfaces including an aspherical surface, according to circumstances. The range sensor 417 need not necessarily be used, and in this case, it is only necessary that the object distance is calculated and the variable mirror is deformed so that a high-frequency component of an image signal from the solid-state image sensor 408 is roughly maximized. When the variable mirror 409 is made by using lithography, high fabrication accuracy and good quality are easily obtained.

When the deforming substrate 409j is made of synthetic resin, such as polyimide or the trade name, Cytop (made by ASAHI GLASS CO., LTD), it can be considerably deformed even at a low voltage, which is advantageous.

In FIG. 17, the thin film 409a of the reflecting surface and the deforming electrode 409k sandwiching the deforming substrate 409j between them are integrally constructed, and thus there is the advantage that some manufacturing methods can be chosen. The thin film 409a of the reflecting surface may be configured as a conductive thin film. By doing so, the thin film 409a can also be used as the deforming electrode 409k. This brings about the advantage that the structure is simplified because both are configured into one unit

It is favorable that the profile of the reflecting surface of the variable mirror is a free-formed surface. This is because correction for aberration can be facilitated, which is advantageous.

Also, although in FIG. 17 the arithmetical unit 414, the temperature sensor 415, the humidity sensor 416, and the range sensor 417 are provided so that the variable mirror 409 compensates for the changes of the temperature, the humidity, and the object distance, the present invention is not limited to this construction. That is, the arithmetical unit 414, the temperature sensor 415, the humidity sensor 416, and the range sensor 417 may be eliminated.

FIG. 18 shows another example of the variable mirror 409. In the variable mirror of this example, a piezoelectric element 409c is interposed between the thin film 409a of the reflecting surface and the electrodes 409b, and these are placed on the support 423. A voltage applied to the piezoelectric element 409c is changed in accordance with each of the electrodes 409b, and thereby the piezoelectric element 409c causes expansion and contraction which are partially different so that the shape of the thin film 409a can be changed. The configuration of the electrodes 409b, as illustrated in FIG. 19, may have a concentric division pattern, or as in FIG. 20, may be a rectangular division pattern. As other patterns, proper configurations can be chosen.

In FIG. 18, reference numeral 424 represents a shake sensor connected to the arithmetical unit 414. The shake sensor 424, for example, detects the shake of a digital camera when the optical apparatus mentioned above is used in the digital camera, and changes the voltages applied to the electrodes 409b through the arithmetical unit 414 and driving circuits 411 housing variable resistors in order to deform the thin film 409a so as to compensate for the blurring of an image caused by the shake. At this time, signals from the temperature sensor 415, the humidity sensor 416, and range sensor 417 are taken into account simultaneously, and focusing and compensation for temperature and humidity are performed. In this case, stress is applied to the thin film 409a by the deformation of the piezoelectric element 409c, and hence it is good practice that the thin film 409a is designed to have a moderate thickness and a proper strength.

The driving circuits 411 are not limited to the construction that a plurality of circuits are arranged in accordance with the number of the electrodes 409b, and may be constructed so that the plurality of electrodes 409b are controlled by a single driving circuit.

FIG. 21 shows still another example of the variable mirror. The variable mirror of this example is constructed with two piezoelectric elements 409c and 409c′ interposed between the thin film 409a and the electrodes 409b and made with substances having piezoelectric characteristics which are reversed in direction. Specifically, the piezoelectric elements 409c and 409c′ are made with ferroelectric crystals and are arranged so that their crystal axes are reversed in direction with respect to each other. In this case, the piezoelectric elements 409c and 409c′ expand or contract in a reverse direction when voltages are applied, and thus there is the advantage that a force for deforming the thin film 409a becomes stronger than in the single layer structure of FIG. 18, and as a result, the shape of the mirror surface can be considerably changed.

For substances used for the piezoelectric elements 409c and 409c′, for example, there are piezoelectric substances such as barium titanate, Rochelle salt, quartz crystal, tourmaline, KDP, ADP, and lithium niobate; polycrystals or crystals of the piezoelectric substances; piezoelectric ceramics such as solid solutions of PbZrO₃ and PbTiO₃; organic piezoelectric substances such as PVDF; and other ferroelectrics. In particular, the organic piezoelectric substance has a small value of Young's modulus and brings about a considerable deformation at a low voltage, which is favorable. When these piezoelectric elements are used, it is also possible to properly deform the thin film 409a in each of the above examples if their thicknesses are made uneven.

As materials of the piezoelectric elements 409c and 409c′, high-polymer piezoelectrics such as polyurethane, silicon rubber, acrylic elastomer, PZT, PLZT, and PVDF; vinylidene cyanide copolymer; and copolymer of vinylidene fluoride and trifluoroethylene are used.

The use of an organic substance, synthetic resin, or elastomer, having a piezoelectric property, is favorable because it brings about a considerable deformation of the surface of the variable mirror.

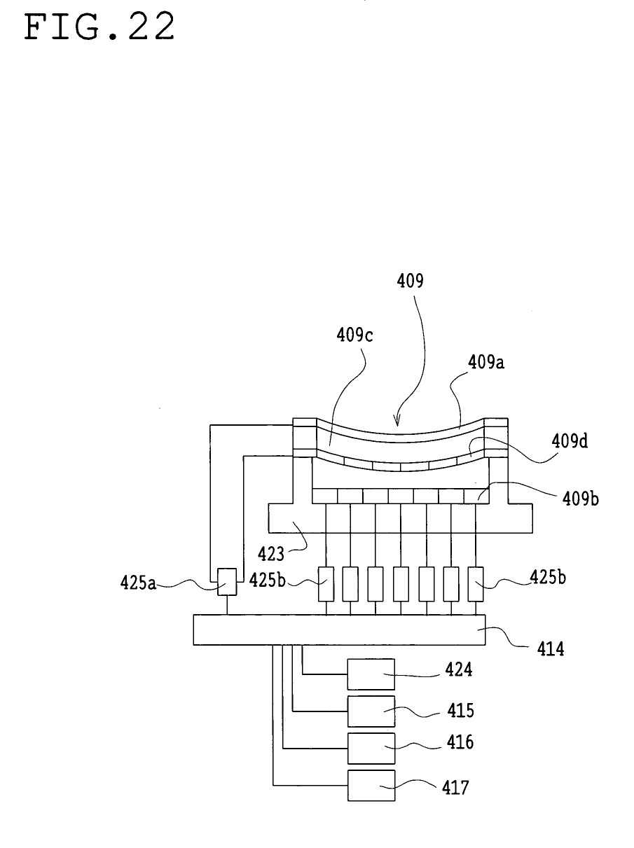

When an electrostrictive substance, for example, acrylic elastomer or silicon rubber, is used for the piezoelectric element 409c shown in FIGS. 18 and 22, the piezoelectric element 409c, instead of the single layer structure, as indicated by a broken line in FIG. 18, may have the two-layer structure in which a substrate 409c-1 is cemented to an electrostrictive substance 409c-2.

FIG. 22 shows another example of the variable mirror 409. The variable mirror of this example is designed so that the piezoelectric element 409c is sandwiched between the thin film 409a and an electrode 409d, and these are placed on the support 423. Voltages are applied to the piezoelectric element 409c between the thin film 409a and the electrode 409d through a driving circuit 425a controlled by the arithmetical unit 414. Furthermore, apart from this, voltages are also applied to the electrodes 409b provided on the support 423, through driving circuits 425b controlled by the arithmetical unit 414. Therefore, in this example, the thin film 409a can be doubly deformed by electrostatic forces due to the voltages applied between the thin film 409a and the electrode 409d and applied to the electrodes 409b. There are advantages that various deformation patterns can be provided and the response is quick, compared with any of the above examples.

By changing the signs of the voltages applied between the thin film 409a and the electrode 409d, the variable mirror can be deformed into either a convex or concave surface. In this case, a considerable deformation may be performed by a piezoelectric effect, while a slight shape change may be carried out by the electrostatic force. Alternatively, the piezoelectric effect may be chiefly used for the deformation of the convex surface, while the electrostatic force may be used for the deformation of the concave surface. Also, the electrode 409d may be constructed as a plurality of electrodes like the electrodes 409b. This state is shown in FIG. 22. In the present invention, all of the piezoelectric effect, the electrostrictive effect, and electrostriction are generally called the piezoelectric effect. Thus, it is assumed that the electrostrictive substance comes into the category of the piezoelectric substance.

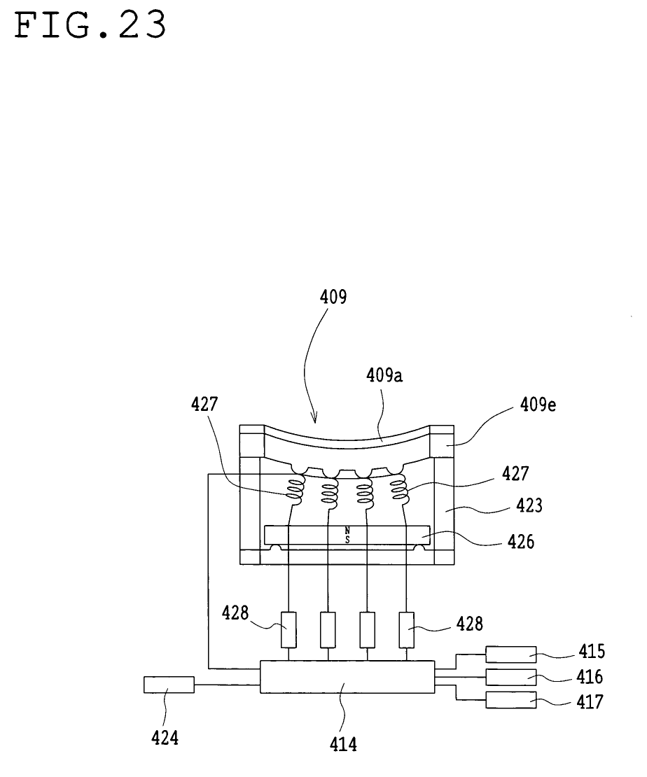

FIG. 23 shows another example of the variable mirror 409. The variable mirror of this example is designed so that the shape of the reflecting surface can be changed by utilizing an electromagnetic force. A permanent magnet 426 is fixed on the bottom surface inside the support 423, and the periphery of a substrate 409e made with silicon nitride or polyimide is mounted and fixed on the top surface thereof. The thin film 409a with the coating of metal, such as aluminum, is deposited on the surface of the substrate 409e, thereby constituting the variable mirror 409. Below the substrate 409e, a plurality of coils 427 are fixedly mounted and are connected to the arithmetical unit 414 through driving circuits 428. In accordance with output signals from the arithmetical unit 414 corresponding to changes of the optical system obtained at the arithmetical unit 414 by signals from the sensors 415, 416, 417, and 424 and others, proper electric currents are supplied from the driving circuits 428 to the coils 427. At this time, the coils 427 are repelled or attracted by the electromagnetic force with the permanent magnet 426 to deform the substrate 409e and the thin film 409a functioning as the reflecting surface.

In this case, a different amount of current can also be caused to flow through each of the coils 427. A single coil 427 may be used. The permanent magnet 426 may be mounted on the lower surface of the substrate 409e so that the coils 427 are arranged on the bottom side in the support 423. It is desirable that the coils 427 are made by a lithography process. A ferromagnetic iron core may be encased in each of the coils 427.

In this case, each of the coils 427, as illustrated in FIG. 24, can be designed so that a coil density varies with the place like a coil 428′, and thereby a desired deformation is brought to the substrate 409e and the thin film 409a. A single coil 427 may be used, or a ferromagnetic iron core may be encased in each of the coils 427.

FIG. 25 shows another example of the variable mirror 409. In the variable mirror of this example, the substrate 409e is made with a ferromagnetic such as iron, and the thin film 409a of the reflecting film is made with aluminum. In this case, since even though the coils are not provided beneath the substrate 409e, the thin film 409a can be deformed by the magnetic force, the structure is simplified and the manufacturing cost can be reduced. If the power switch 413 is replaced with a changeover and power on-off switch, the directions of currents flowing through the coils 427 can be changed, and the configurations of the substrate 409e and the thin film 409a can be changed at will.

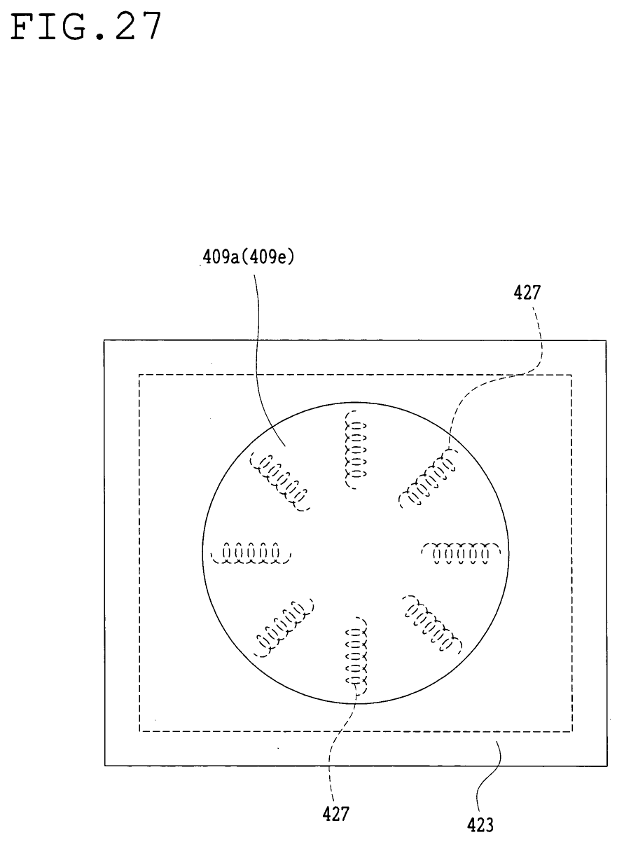

FIG. 26 shows an example of an array of the coils 427 of this example. FIG. 27 shows another example of the array of the coils 427. These arrays are also applicable to the example of FIG. 23.

FIG. 28 shows an array of the permanent magnets 426 suitable for the case where the coils 427, as shown in FIG. 27, are radially arrayed. Specifically, when the barshaped permanent magnets 426, as shown in FIG. 28, are radially arrayed, a delicate deformation can be provided to the substrate 409e and the thin film 409a in contrast with the example of FIG. 23. As mentioned above, when the electromagnetic force is used to deform the substrate 409e and the thin film 409a (in the examples of FIGS. 23 and 25), there is the advantage that they can be driven at a lower voltage than in the case where the electrostatic force is used.

Some examples of the variable mirrors have been described, but as shown in the example of FIG. 22, at least two kinds of forces may be used in order to change the shape of the mirror constructed with a thin film. Specifically, at least two of the electrostatic force, electromagnetic force, piezoelectric effect, magnetrostriction, pressure of a fluid, electric field, magnetic field, temperature change, and electromagnetic wave, may be used simultaneously to deform the thin film constituting the reflecting surface. That is, when at least two different driving techniques are used to make the variable optical-property element, a considerable deformation and a slight deformation can be achieved simultaneously and a mirror surface with a high degree of accuracy can be obtained.

FIG. 29 shows an imaging system which uses the variable mirror 409 applicable to the optical apparatus of another embodiment of the present invention and which is used, for example, in a digital camera of a mobile phone, a capsule endoscope, an electronic endoscope, a digital camera for personal computers, or a digital camera for PDAs.

In this imaging system, one imaging unit 104 is constructed with the deformable mirror 409, a lens 902, the solid-state image sensor 408, and a control system 103. The imaging unit 104 of this embodiment is designed so that light from an object passing through the lens 902 is condensed by the variable mirror 409 and is imaged on the solid-state image sensor 408. The variable mirror 409 is a kind of variable optical-property element and is also referred to as the variable focal-length mirror.

According to the embodiment, even when the object distance is changed, the variable mirror 409 is deformed and thereby the object can be brought into a focus. The embodiment need not move the lens 902 by using a motor and excels in compact and lightweight design and low power consumption. The imaging unit 104 can be used in any of the embodiments as the imaging optical system of the present invention. When a plurality of variable mirrors 409 are used, an optical system, such as a zoom imaging optical system or a variable magnification imaging optical system, can be constructed.

In FIG. 29, an example of a control system is cited which includes the boosting circuit of a transformer using coils in the control system 103. In particular, the use of a laminated piezoelectric transformer is favorable because a compact design can be achieved. The boosting circuit can be used in the variable mirror or the variable focal-length lens which uses electricity, and is particularly useful for the variable mirror or the variable focal-length lens which utilizes the electrostatic force or the piezoelectric effect. In order to use the variable mirror 409 for focusing, it is only necessary, for example, to form an object image on the solid-state image sensor 408 and to find a state where the high-frequency component of the object image is maximized while changing the focal length of the variable mirror 409. In order to detect the high-frequency component, it is only necessary, for example, to connect a processor including a microcomputer to the solid-state image sensor 408 and to detect the high-frequency component therein.

FIG. 30 shows another example of the variable mirror. In this figure, a variable mirror 188 is constructed so that a fluid 161 is taken in and out by a micropump 180 to deform a mirror surface which is configured with a film extended on the upper surface of a support 189a. According to this embodiment, there is the advantage that the mirror surface can be considerably deformed. In this figure, reference numeral 168 denotes a control device controlling the amount of the fluid 161 in the support 189a, together with the micropump 180. The control device 168 and the micropump 180 are to control the deformation of a film 189, and thus correspond to the driving circuit.

The micropump 180 is a small-sized pump, for example, made by a micromachining technique and is constructed so that it is operated with an electric force. As examples of pumps made by the micromachining technique, there are those which use thermal deformations, piezoelectric substances, and electrostatic forces.

FIG. 31 shows an example of the micropump 180 of FIG. 30. In the micropump 180 of this example, a vibrating plate 181 is vibrated by the electrostatic force or the electric force of the piezoelectric effect. In FIG. 31, a case where the vibrating plate is vibrated by the electrostatic force is shown and reference numerals 182 and 183 represent electrodes. Dotted lines indicate the vibrating plate 181 where it is deformed. When the vibrating plate 181 is vibrated, two valves 184 and 185 are opened and closed to feed the fluid 161 from the right to the left.

In the variable mirror 188 shown in FIG. 30, the film 189 constituting the reflecting surface is deformed into a concave or convex shape in accordance with the amount of the fluid 161, thereby functioning as the variable mirror. An organic or inorganic substance, such as silicon oil, air, water, or jelly, can be used as the fluid.

In the variable mirror or the variable focal-length lens which uses the electrostatic force or the piezoelectric effect, a high voltage is sometimes required for drive. In this case, for example, as shown in FIG. 29, it is desirable that the boosting transformer or the piezoelectric transformer is used to constitute the control system.

The provision of the thin film 409a or the film 189 which constitutes the reflecting surface on a member which is not deformed like the upper portion of the annular member of the support 423 or 189a is convenient because it can be used as a reference surface when the profile of the reflecting surface of the variable mirror is measured by an interferometer.

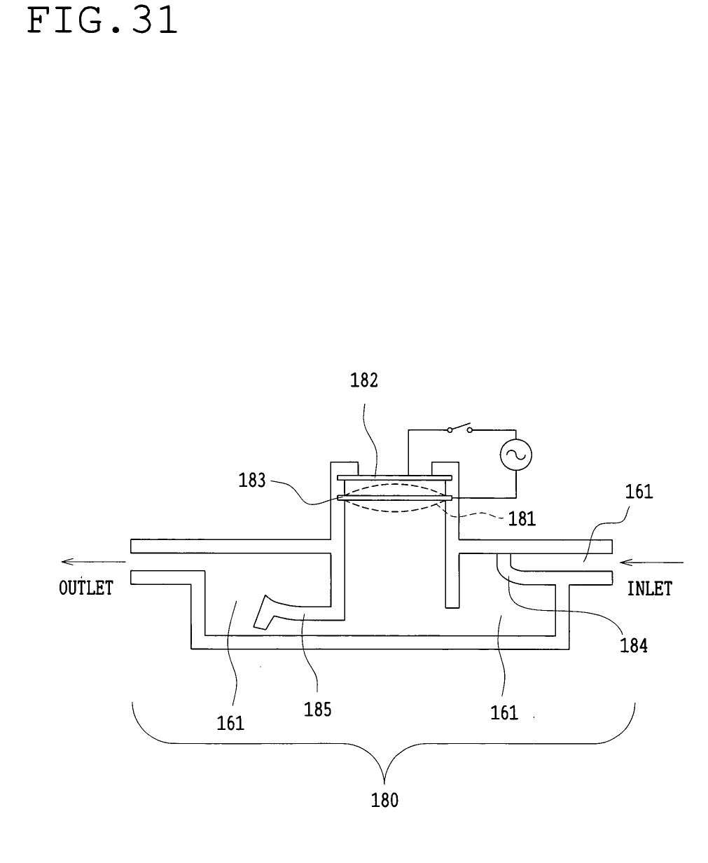

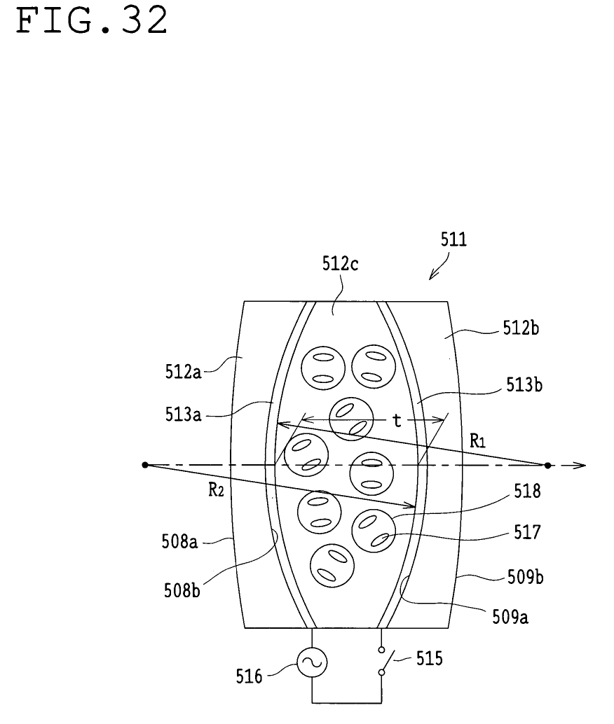

FIG. 32 shows the principle structure of the variable focal-length lens of another type. A variable focal-length lens 511 includes a first lens 512a having lens surfaces 508a and 508b as a first surface and a second surface, respectively; a second lens 512b having lens surfaces 509a and 509b as a third surface and a fourth surface, respectively; and a third lens 512c constructed with a macromolecular dispersed liquid crystal layer 514 sandwiched between the first and second lenses through transparent electrodes 513a and 513b. Incident light is converged through the first, third, and second lenses 512a, 512c, and 512b. The transparent electrodes 513a and 513b are connected to an alternating-current power supply 516 through a switch 515 so that an alternating-current voltage is selectively applied to the macromolecular dispersed liquid crystal layer 514. The macromolecular dispersed liquid crystal layer 514 is composed of a great number of minute macromolecular cells 518, each having any shape, such as a sphere or polyhedron, and including liquid crystal molecules 517. The volume of each cell is equal to the sum of volumes occupied by macromolecules and the liquid crystal molecules 517 which constitute the macromolecular cell 518.

Here, for the size of each of the macromolecular cells 518, for example, in the case of a sphere, when an average diameter is denoted by D and the wavelength of light used is denoted by λ, the average diameter D is chosen to satisfy the following condition:
2 nm≦D≦λ/5 (9)
That is, the size of each of the liquid crystal molecules 517 is at least about 2 nm and thus the lower limit of the average diameter D is set to 2 nm or larger. The upper limit of the diameter D depends on a thickness t of the macromolecular dispersed liquid crystal layer 514 in the direction of the optical axis of the variable focal-length lens 511. However, if the diameter is larger than the wavelength λ, a difference in refractive index between the macromolecule and the liquid crystal molecule 517 will cause light to be scattered at the interface of the macromolecular cell 518 and will render the liquid crystal layer 514 opaque. Hence, the upper limit of the diameter D, as described later, should preferably be λ/5 or less. A high degree of accuracy is not necessarily required, depending on an optical product using the variable focal-length lens. In this case, the diameter D below the value of the wavelength λ is satisfactory. Also, the transparency of the macromolecular dispersed liquid crystal layer 514 deteriorates with increasing thickness t. In the liquid crystal molecules 517, for example, uniaxial nematic liquid crystal molecules are used. The index ellipsoid of each of the liquid crystal molecules 517 is as shown in FIG. 33. That is,
nₒₓ=n_{oy}=nₒ (10)
where no is the refractive index of an ordinary ray, and nₒₓ and n_{oy} are refractive indices in directions perpendicular to each other in a plane including ordinary rays.

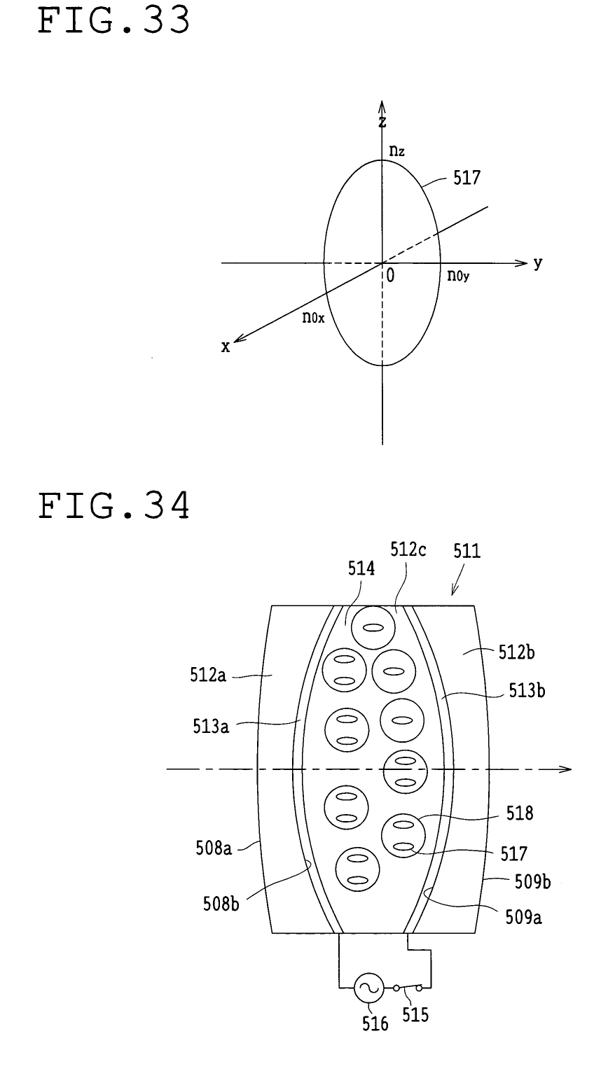

Here, in the case where the switch 515, as shown in FIG. 32 is turned off, that is, the electric field is not applied to the liquid crystal layer 514, the liquid crystal molecules 517 are oriented in various directions, and thus the refractive index of the liquid crystal layer 514 relative to incident light becomes high to provide a lens with strong refracting power. In contrast to this, when the switch 515, as shown in FIG. 34, is turned on and the alternating-current voltage is applied to the liquid crystal layer 514, the liquid crystal molecules 517 are oriented so that the major axis of the index ellipsoid of each liquid crystal molecule 517 is parallel with the optical axis of the variable focal-length lens 511, and hence the refractive index becomes lower to provide a lens with weaker refracting power.

The voltage applied to the macromolecular dispersed liquid crystal layer 514, for example, as shown in FIG. 35, can be changed stepwise or continuously by the use of a variable resistor 519. By doing so, as the applied voltage becomes high, the liquid crystal molecules 517 are oriented so that the major axis of the index ellipsoid of each liquid crystal molecule 517 becomes progressively parallel with the optical axis of the variable focal-length lens 511, and thus the refractive index can be changed stepwise or continuously.

Here, in the case of FIG. 32, that is, in the case where the voltage is not applied to the macromolecular dispersed liquid crystal layer 514, when the refractive index in the direction of the major axis of the index ellipsoid, as shown in FIG. 33, is denoted by n_{z}, an average refractive index n_{LC}′ of the liquid crystal molecules 517 is roughly given by
(nₒₓ+n_{oy}+n_{z})3≡n_{LC}′ (11)
Also, when the refractive index n_{z} is expressed as a refractive index ne of an extraordinary ray, an average refractive index n_{LC} of the liquid crystal molecules 517 where Equation (10) is established is given by
(2nₒ+nₑ)/3≡n_{LC} (12)
In this case, when the refractive index of each of the macromolecules constituting the macromolecular cells 518 is represented by nₚ and the ratio of volume between the liquid crystal layer 514 and the liquid crystal molecules 517 is represented by ff, a refractive index n_{A} of the liquid crystal layer 514 is given from the Maxwell-Garnet's law as
n_{A}=ff·n_{LC}′+(1−ff)nₚ (13)

Thus, as shown in FIG. 35, when the radii of curvature of the inner surfaces of the lenses 512a and 512b, that is, the surfaces on the side of the liquid crystal layer 514, are represented by R₁ and R₂, a focal length f₁ of the third lens 512c constructed with the liquid crystal layer 514 is given by
1/f₁=(n_{A}−1)(1/R₁−1/R₂) (14)
Also, when the center of curvature is located on the image side, it is assumed that each of the radii of curvature R₁ and R₂ is positive. Refraction caused by the outer surface of each of the lenses 512a and 512b is omitted. That is, the focal length of the lens 512c constructed with only the liquid crystal layer 514 is given by Equation (14).

When the average refractive index of ordinary rays is expressed as
(nₒₓ+n_{oy})/2=nₒ′ (15)
a refractive index n_{B} of the liquid crystal layer 514 in the case of FIG. 34, namely, in the case where the voltage is applied to the liquid crystal layer 514, is given by
n_{B}=ff·nₒ′+(1−ff)nₚ (16)
and thus a focal length f₂ of the lens 512c constructed with only the liquid crystal layer 514 in this case is given by
1/f₂=(n_{B}−1)(1/R₁−1/R₂) (17)
Also, the focal length where a lower voltage than in FIG. 34 is applied to the liquid crystal layer 514 takes a value between the focal length f₁ given by Equation (14) and the focal length f₂ by Equation (17).

From Equations (14) and (17), a change rate of the focal length of the lens constructed with the liquid crystal layer 514 is given by
|(f₂−f₁)/f₂|=|(n_{B}−n_{A})/(n_{A}−1)| (18)

Thus, in order to increase the change rate, it is only necessary to increase the value of |n_{B}−n_{A}|. Here,
n_{B}−n_{A}=ff(nₒ′−n_{LC}′) (19)
and hence if the value of |nₒ′−n_{LC}′| is increased, the change rate can be raised. Practically, since the refractive index n_{B} of the liquid crystal layer 514 is about 1.3-2, the value of |nₒ′−n_{LC}′| is chosen so as to satisfy the following condition:
0.01≦|nₒ′−n_{LC}′|≦10tm (20)
In this way, when ff=0.5, the focal length of the lens constructed with the liquid crystal layer 514 can be changed by at least 0.5%, and thus an effective variable focal-length lens can be obtained. Also, the value of |nₒ′−n_{LC}40 | cannot exceed 10 because of restrictions on liquid crystal substances.

Subsequently, a description will be given of grounds for the upper limit of Condition (9). The variation of a transmittance T where the size of each cell of a macromolecular dispersed liquid crystal is changed is described in “Transmission variation using scattering/transparent switching films” on pages 197-214 of “Solar Energy Materials and Solar Cells”, Wilson and Eck, Vol. 31, Eleesvier Science Publishers B. v., 1993. In FIG. 6 on page 206 of this publication, it is shown that when the radius of each cell of the macromolecular dispersed liquid crystal is denoted by r, t=300 μm, ff=0.5, nₚ=1.45, n_{LC}=1.585, and λ=500 nm, the theoretical value of the transmittance τ is about 90% if r=5 nm (D=λ/50 and D·t=λ·6 μm, where D and λ are expressed in nanometers), and is about 50% if r=25 nm (D=λ/10).

Here, it is assumed that t=150 μm and the transmittance t varies as the exponential function of the thickness t. The transmittance t in the case of t=150 μm is nearly 71% when r=25 nm (D=λ/10 and D·t=λ·15 μm). Similarly, in the case of t=75 μm, the transmittance τ is nearly 80% when r=25 nm (D=λ/10 and D·t=λ·7.5 μm).

From these results, the transmittance t becomes at least 70-80% and the liquid crystal can be actually used as a lens, if the liquid crystal satisfies the following condition:
D·t≦λ·15 μm (21)
Hence, for example, in the case of t=75 μm, if D≦λ/5, a satisfactory transmittance can be obtained.

The transmittance of the macromolecular dispersed liquid crystal layer 514 is raised as the value of the refractive index nₚ approaches the value of the refractive index n_{LC}″ On the other hand, if the values of the refractive indices nₒ′ and nₚ are different from each other, the transmittance of the liquid crystal layer 514 will be degraded. In FIGS. 32 and 34, the transmittance of the liquid crystal layer 514 is improved on an average when the liquid crystal layer 514 satisfies the following equation:
nₚ=(nₒ′+n_{LC}′)/2 (22)

The variable focal-length lens 511 is used as a lens, and thus in both FIGS. 32 and 34, it is desirable that the transmittances are almost the same and high. For this, although there are limits to the substances of the macromolecules and the liquid crystal molecules 517 constituting the macromolecular cells 518, it is only necessary, in practical use, to satisfy the following condition:
nₒ′≦nₚ≦n_{LC}′ (23)

When Equation (22) is satisfied, Condition (21) is moderated and it is only necessary to satisfy the following condition:
D·t≦λ·60 μm (24)
It is for this reason that, according to the Fresnel's law of reflection, the reflectance is proportional to the square of the difference of the refractive index, and thus the reflection of light at the interfaces between the macromolecules and the liquid crystal molecules 517 constituting the macromolecular cells 518, that is, a reduction in the transmittance of the liquid crystal layer 514, is roughly proportional to the square of the difference in refractive index between the macromolecules and the liquid crystal molecules 517.

In the above description, reference has been made to the case where nₒ′≈1.45 and n_{LC}′≈1.585, but in a more general formulation, it is only necessary to satisfy the following condition:
D·t≦λ15 μm·(1.585−1.45)²/(nᵤ−nₚ)² (25)
where (nᵤ−nₚ)² is a value when one of (n_{LC}′−nₚ)² and (nₒ′−nₚ)² is larger than the other.

In order to largely change the focal length of the variable focal-length lens 511, it is favorable that the ratio ff is as high as possible, but in the case of ff=1, the volume of the macromolecule becomes zero and the macromolecular cells 518 cease to be formable. Thus, it is necessary to satisfy the following condition:
0.1≦ff≦0.999 (26)

On the other hand, the transmittance T improves as the ratio ff becomes low, and hence Condition (25) may be moderated, preferably, as follows:
4×10⁻⁶ [μm]²≦D·t≦λ45 μm(1.585−1.45)²/(nᵤ−nₚ)² (27)
Also, the lower limit of the thickness t, as is obvious from FIG. 32, corresponds to the diameter D, which is at least 2 nm as described above, and therefore the lower limit of D·t becomes (2×10⁻³ μm)², namely 4×10⁻⁶ [μm]².

An approximation where the optical property of substance is represented by the refractive index is established when the diameter D is 5-10 nm or larger, as set forth in “Iwanami Science Library 8, Asteroids are coming”, T. Mukai, Iwanami Shoten, p. 58, 1994. If the value of the diameter D exceeds 500 λ, the scattering of light will be changed geometrically, and the scattering of light at the interfaces between the macromolecules and the liquid crystal molecules 517 constituting the macromolecular cells 518 is increased in accordance with the Fresnel's equation of reflection. As such, in practical use, the diameter D must be chosen so as to satisfy the following condition:
7 nm≦D≦500 λ (28)

FIG. 36 shows an imaging optical system using the variable focal-length lens 511 of FIG. 35 provided between an aperture stop 521 and the image sensor in the optical apparatus of the present invention, for example, an example where the variable focal-length lens 511 is used in an imaging optical system for digital cameras. In this imaging optical system, an image of an object (not shown) is formed on a solid-state image sensor 523, such as a CCD, through the stop 521, the variable focal-length lens 511, and a lens 522. Also, in FIG. 36, the liquid crystal molecules are not shown.

According to such an imaging optical system, the alternating-current voltage applied to the macromolecular dispersed liquid crystal layer 514 of the variable focal-length lens 511 is controlled by the variable resistor 519 to change the focal length of the variable focal-length lens 511. Whereby, without moving the variable focal-length lens 511 and the lens 522 along the optical axis, it becomes possible to perform continuous focusing with respect to the object distance, for example, from the infinity to 600 mm.

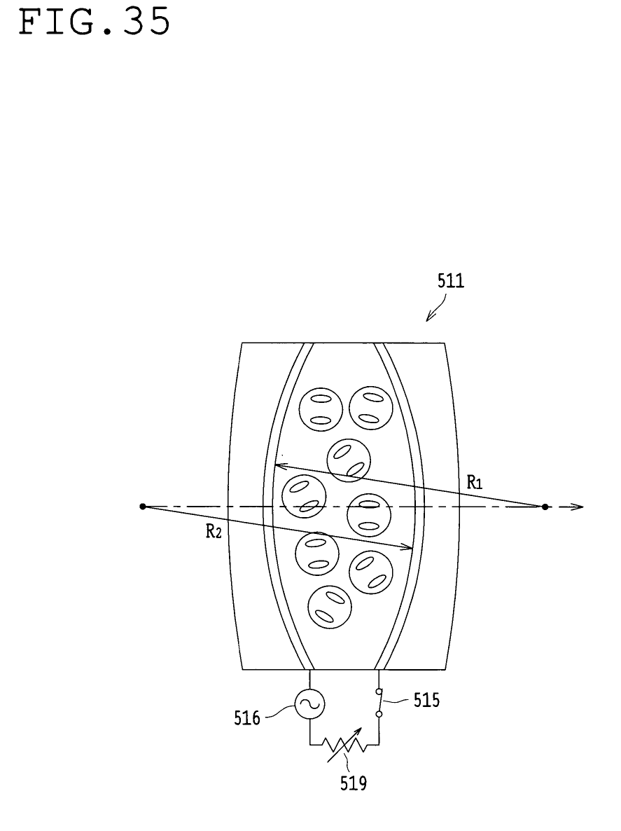

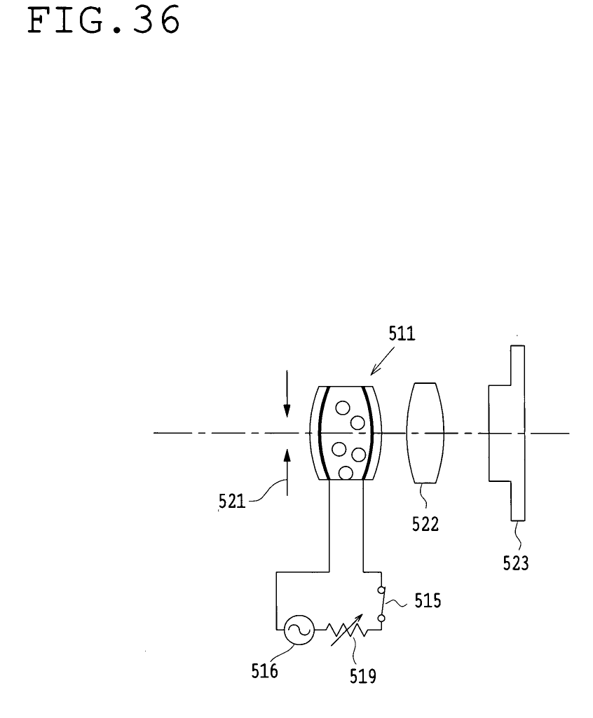

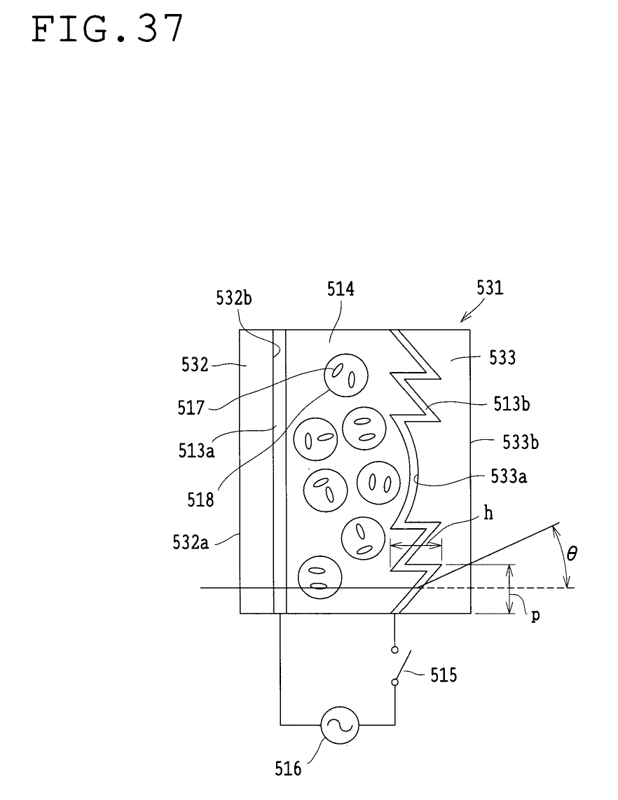

FIG. 37 shows one example of a variable focal-length diffraction optical element used so that the focal length of the imaging optical system can be changed, like the variable focal-length lens of FIG. 35, in the optical apparatus of the present invention.

A variable focal-length diffraction optical element 531 of this example includes a first transparent substrate 532 having a first surface 532a and a second surface 532b which are parallel with each other and a second transparent substrate 533 having a third surface 533a which is constructed with an annular diffraction grating of saw-like cross section having the depth of a groove corresponding to the wavelength of light and a fourth surface 533b which is flat. Incident light emerges through the first and second transparent substrates 532 and 533. Between the first and second transparent substrates 532 and 533, as in FIG. 32, the macromolecular dispersed liquid crystal layer 514 is sandwiched through the transparent electrodes 513a and 513b so that the transparent electrodes 513a and 513b are connected to the alternating-current power supply 516 through the switch 515 and the alternating-current voltage is applied to the macromolecular dispersed liquid crystal layer 514.

In such a structure, when the grating pitch of the third surface 533a is represented by p and an integer is represented by m, a ray of light incident on the variable focal-length diffraction optical element 531 is deflected by an angle θ satisfying the following equation:
p sin θ=mλ (29)
and emerges therefrom. When the depth of the groove is denoted by h, the refractive index of the transparent substrate 533 is denoted by n₃₃, and an integer is denoted by k, a diffraction efficiency becomes 100% at the wavelength λ and the production of flare can be prevented by satisfying the following equations:
h(n_{A}−n₃₃)=mλ (30)
h(n_{B}−n₃₃)=kλ (31)

Here, the difference in both sides between Equations (30) and (31) is given by
h(n_{A}−n_{B})=(m−k)λ (32)
Therefore, when it is assumed that λ=500 nm, n_{A}=1.55, and n_{B}=1.5,
0.05 h=(m−k)·500 nm
and when m=1 and k=0,
h=10000 nm=10 μm
In this case, it is favorable that the refractive index n₃₃ of the transparent substrate 533 is obtained as 1.5 from Equation (30). When the grating pitch p on the periphery of the variable focal-length diffraction optical element 531 is assumed to be 10 μm, θ≈2.87° and a lens with an F-number of 10 can be obtained.

The variable focal-length diffraction optical element 531, whose optical path length is changed by the on-off operation of the voltage applied to the liquid crystal layer 514, for example, can be used for focus adjustment in such a way that it is placed at a portion where the light beam of a lens system is not parallel, or can be used to change the focal length of the entire lens system.

In this example, it is only necessary that Equations (30)-(32) are set in practical use to satisfy the following conditions:
0.7 mλ≦h(n_{A}−n₃₃)<1.4 mλ (33)
0.7kλ≦h(n_{A}−n₃₃)<1.4kλ (34)
0.7(m−k)<h(n_{A}−n_{B})<1.4(m−k) (35)

A variable focal-length lens using a twisted nematic liquid crystal also falls into the category of the present invention. FIGS. 38 and 39 show variable focal-length spectacles 550 in this case. A variable focal-length lens 551 has lenses 552 and 553, orientation films 539a and 539b provided through the transparent electrodes 513a and 513b, respectively, inside these lenses, and a twisted nematic liquid crystal layer 554 sandwiched between the orientation films. The transparent electrodes 513a and 513b are connected to the alternating-current power supply 516 through the variable resistor 519 so that the alternating-current voltage is applied to the twisted nematic liquid crystal layer 554.

In this structure, when the voltage applied to the twisted nematic liquid crystal layer 554 is increased, liquid crystal molecules 555, as illustrated in FIG. 39, exhibit a homeotropic orientation, so that the refractive index of the liquid crystal layer 554 is lower and the focal length is longer than in a twisted nematic state of FIG. 38 in which the applied voltage is low.

A spiral pitch P of the liquid crystal molecules 555 in the twisted nematic state of FIG. 38 must be made nearly equal to, or much smaller than, the wavelength k of light, and thus is set to satisfy the following condition:
2 nm≦P≦2λ/3 (36)

Also, the lower limit of this condition depends on the sizes of the liquid crystal molecules 555, while the upper limit is a value necessary for the behavior of the liquid crystal layer 554 as an isotropic medium in a state of FIG. 38 when incident light is natural light. If the upper limit of the condition is overstepped, the variable focal-length lens 551 is changed to a lens in which the focal length varies with the direction of deflection. Hence, a double image is formed and only a blurred image is obtained. However, when a very high degree of accuracy is not required, the upper lit of Condition (36) may be set to 3λ. In the application with less accuracy, the upper limit may be set to 5λ.

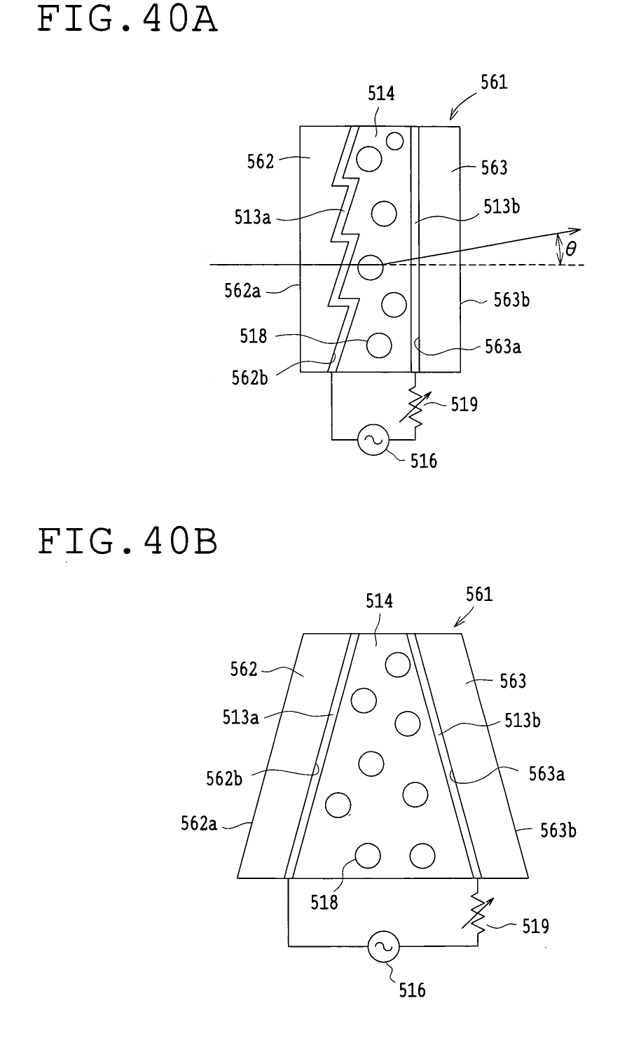

FIG. 40A shows an example of a variable deflection-angle prism applicable to the optical system used in the optical apparatus of the present invention. A variable deflection-angle prism 561 includes a first transparent substrate 562 on the entrance side, having a first surface 562a and a second surface 562b; and a second transparent substrate 563 like a plane-parallel plate on the exit side, having a third surface 563a and a fourth surface 563b. The inner surface (the second surface) 562b of the transparent substrate 562 on the entrance side is configured into a Fresnel form, and the macromolecular dispersed liquid crystal layer 514, as in FIG. 32, is sandwiched between this transparent substrate 562 and the transparent substrate 563 on the exit side through the transparent electrodes 513a and 513b. The transparent electrodes 513a and 513b are connected to the alternating-current power supply 516 through the variable resistor 519. Whereby, the alternating-current voltage is applied to the liquid crystal layer 514 so that a deflection angle θ of light transmitted through the variable deflection-angle prism 561 is controlled. Also, in FIG. 40A, the inner surface 562b of the transparent substrate 562 is configured into the Fresnel form, but as shown in FIG. 40B, the inner surfaces of the transparent substrates 562 and 563 may be configured like an ordinary prism whose surfaces are relatively inclined, or may be configured like the diffraction grating shown in FIG. 37. In the case of the latter, Equations (29)-(32) and Conditions (33)-(35) apply equally.

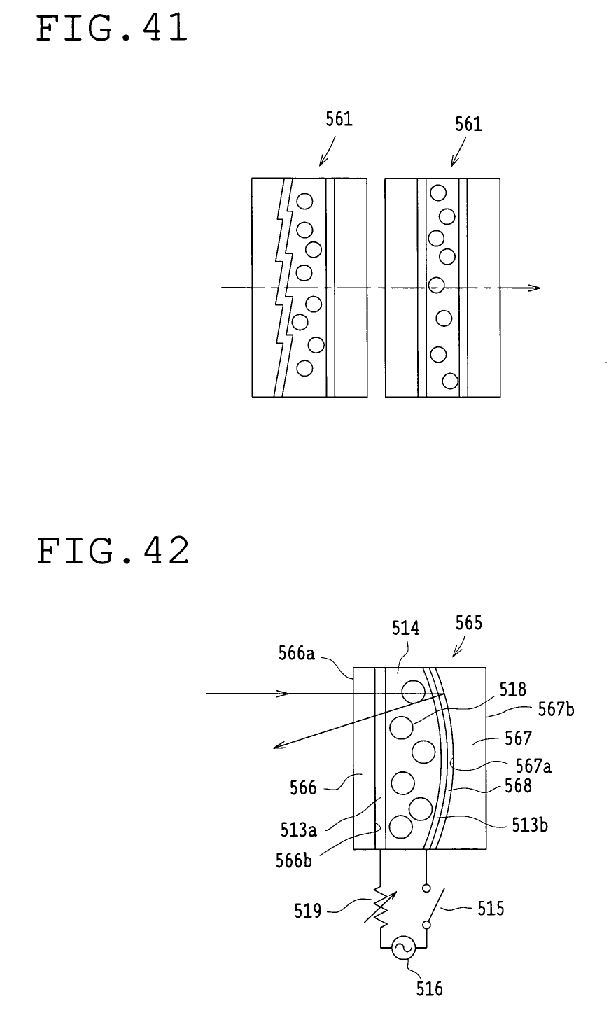

The variable deflection-angle prism 561 constructed mentioned above is used in each of the optical systems, for example, of TV cameras, digital cameras, film cameras, or binoculars, and thereby can be effectively used for shake prevention. In this case, it is desirable that the direction of refraction (deflection) of the variable deflection-angle prism 561 is vertical. In order to further improve its performance, it is desirable that two variable deflection-angle prisms 561 are arranged so that the directions of deflection of the prisms 561 are varied and as shown in FIG. 41, the refraction angles are changed in vertical and lateral directions. Also, in FIGS. 40A, 40B, and 41, the liquid crystal molecules are omitted.

FIG. 42 shows an example of a variable focal-length mirror used instead of the variable mirror, that is, configured by providing a reflecting film on one surface of the variable focal-length lens, in the optical system of the optical apparatus.

A variable focal-length mirror 565 of this example includes a first transparent substrate 566 having a first surface 566a and a second surface 566b, and a second transparent substrate 567 having a third surface 567a and a fourth surface 567b. The first transparent substrate 566 is configured into a flat plate shape or a lens shape to provide the transparent electrode 513a on the inner surface (the second surface) 566b. The second transparent substrate 567 is such that the inner surface (the third surface) 567a is configured as a concave surface, on which a reflecting film 568 is deposited, and the transparent electrode 513b is provided on the reflecting film 568. Between the transparent electrodes 513a and 513b, as in FIG. 32, the macromolecular dispersed liquid crystal layer 514 is sandwiched so that the transparent electrodes 513a and 513b are connected to the alternating-current power supply 516 through the switch 515 and the variable resistor 519, and the alternating-current voltage is applied to the macromolecular dispersed liquid crystal layer 514. Also, in FIG. 42, the liquid crystal molecules are omitted.

According to the above structure, since a ray of light incident from the side of the transparent substrate 566 is passed again through the liquid crystal layer 514 by the reflecting film (reflecting surface) 568, the function of the liquid crystal layer 514 can be exercised twice, and the focal position of reflected light can be shifted by changing the voltage applied to the liquid crystal layer 514. In this case, the ray of light incident on the variable focal-length mirror 565 is transmitted twice through the liquid crystal layer 514, and therefore when a thickness twice that of the liquid crystal layer 514 is represented by t, the conditions mentioned above can be used. Moreover, the inner surface of the transparent substrate 566 or 567 can also be configured into a diffraction grating shape, such as that shown in FIG. 37, to reduce the thickness of the liquid crystal layer 514. This offers the advantage that the amount of scattered light can be made smaller.

In the above description, in order to prevent the deterioration of the liquid crystal, the alternating-current power supply 516 is used as a voltage source to apply the alternating-current voltage to the liquid crystal. However, a direct-current power supply is used and thereby a direct-current voltage can also be applied to the liquid crystal. Techniques of shifting the orientation of the liquid crystal molecules, in addition to changing the voltage, can be achieved by changing the frequency of the electric field applied to the liquid crystal, the strength and frequency of the magnetic field applied to the liquid crystal, and the temperature of the liquid crystal. In the above description, some of macromolecular dispersed liquid crystals are close to solids, rather than liquids. In this case, therefore, one of the lenses 512a and 512b, the transparent substrates 532, the lens 538, one of the lenses 552 and 553, the transparent substrate 563 in FIG. 40A, one of the transparent substrates 562 and 563 in FIG. 40B, or one of the transparent substrates 566 and 567, may be eliminated.

The optical element of the type that the focal length of the optical element is changed by altering the refracting index of a medium, such as that described in FIGS. 32-42, has the advantages that since the shape is not changed, a mechanical design is easy and a mechanical structure becomes simple.

FIG. 43 shows an example of an imaging optical system using a variable focal-length lens 140 ahead of the image sensor 408 in the optical apparatus. The imaging optical system can be used as an imaging unit 141.

In this example, a lens 102 and the variable focal-length lens 140 constitute an imaging lens system. This imaging lens system and the image sensor 408 constitute the imaging unit 141. The variable focal-length lens 140 is constructed with a transparent member 142; a soft transparent substance 143, such as piezoelectric synthetic resin, enclosed between a pair of transparent electrodes 145; and a light-transmitting fluid or a jelly-like substance 144 sandwiched between the transparent member 142 and the transparent electrode 145.

As the fluid or the jelly-like substance 144, silicon oil, elastic rubber, jelly, or water can be used. The transparent electrodes 145 are provided on both sides of the transparent substance 143, and when the voltage is applied through a circuit 103′ to the transparent electrodes 145, the transparent substance 143 is deformed by the piezoelectric effect of the transparent substance 143 so that the focal length of the variable focal-length lens 140 is changed.

Thus, according to the example, even when the object distance is changed, focusing can be performed without moving the imaging optical system with a motor, and as such the example excels in compact and lightweight design and low power consumption.

Again, in FIG. 43, reference numeral 145 denotes transparent electrodes and 146 denotes a cylinder for storing a fluid.

For the transparent substance 143, high-polymer piezoelectrics such as polyurethane, silicon rubber, acrylic elastomer, PZT, PLZT, and PVDF; vinylidene cyanide copolymer; or copolymer of vinylidene fluoride and trifluoroethylene is used.

The use of an organic substance, synthetic resin, or elastomer, having a piezoelectric property, is favorable because a considerable deformation of the surface of the variable focal-length lens is brought about. It is good practice to use a transparent piezoelectric substance for the variable focal-length lens.

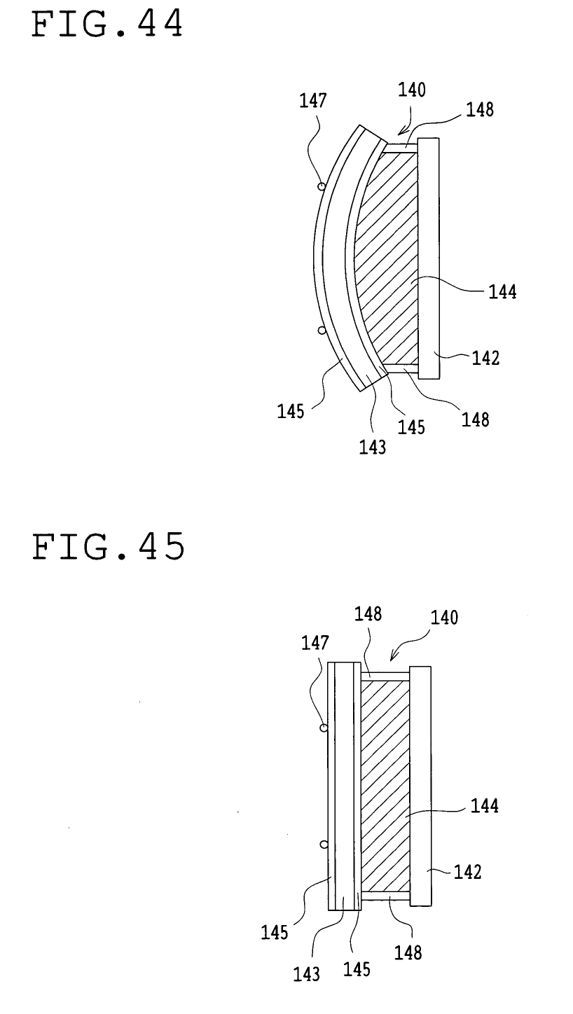

In FIG. 43, instead of using the cylinder 146, the variable focal-length lens 140, as shown in FIG. 44, may be designed so that annular supporting members 147 are provided at the position parallel with the transparent member 142 and a distance between the transparent member 142 and the supporting members 147 is maintained.

In FIG. 44, the transparent substance 143 enclosed between the pair of electrodes 143 and the fluid or the jelly-like substance 144 covered with a periphery-deformable member 148 are interposed between the supporting members 147 and the transparent member 142. Even when the voltage is applied to the transparent substance 143 and thereby the transparent substance 143 is deformed, as shown in FIG. 45, the deformable member 148 is deformed so that the entire volume of the variable focal-length lens 140 is not changed. As such, the cylinder 146 becomes unnecessary. In FIGS. 44 and 45, the deformable member 148 is made with an elastic body, accordion-shaped synthetic resin, or metal.

In each of the examples shown in FIGS. 43 and 44, when a reverse voltage is applied, the transparent substance 143 is deformed in a reverse direction, and thus it is also possible to construct a concave lens.

Where an electrostrictive substance, for example, acrylic elastomer or silicon rubber, is used for the transparent substance 143, it is desirable that the transparent substance 143 is constructed so that the transparent substrate and the electrostrictive substance are cemented to each other.

FIG. 46 shows a variable focal-length lens 167 in which the fluid 161 is taken in and out by micropumps 160 to deform the lens surface, in another example of the variable focal-length lens applicable to the imaging optical system of the optical apparatus according to the present invention.

Each of the micropumps 160 is a small-sized pump, for example, made by a micromachining technique and is constructed so that it is operated with an electric force. The fluid 161 is sandwiched between a transparent substrate 163 and a transparent elastic body 164. In FIG. 46, reference numeral 165 represents a transparent substrate for protecting the elastic body 164, but this substrate is not necessarily required.

As examples of pumps made by the micromachining technique, there are those which use thermal deformations, piezoelectric substances, and electrostatic forces.

It is only necessary to use two micropumps, for example, like the micropumps 160 used in the variable focal-length lens of FIG. 46, each of which is the micropump 180 such as that shown in FIG. 31.

In the variable focal-length lens which uses the electrostatic force or the piezoelectric effect, a high voltage is sometimes required for drive. In this case, it is desirable that the boosting transformer or the piezoelectric transformer is used to constitute the control system. In particular, the use of a laminated piezoelectric transformer is favorable because a compact design can be achieved.

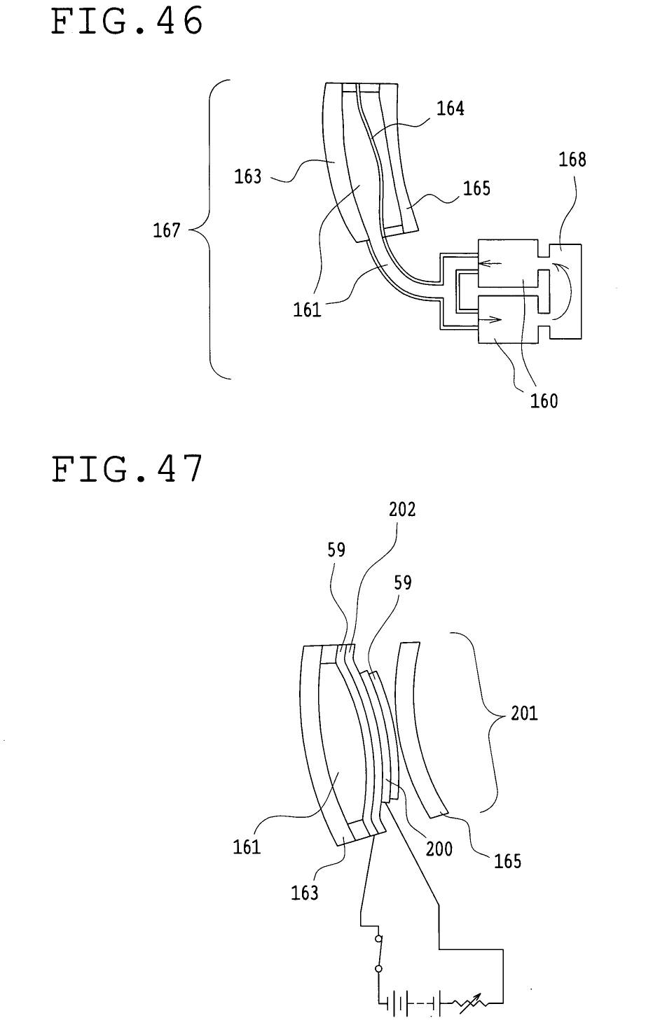

FIG. 47 shows a variable focal-length lens 201 using a piezoelectric substance 200, in another example of a variable optical-property element applicable to the optical system of the optical apparatus. The same substance as the transparent substance 143 is used for the piezoelectric substance 200, which is provided on a soft transparent substrate 202. It is desirable that synthetic resin or an organic substance is used for the substrate 202.

In the example, the voltage is applied to the piezoelectric substance 200 through two transparent electrodes 59, and thereby the piezoelectric substance 200 is deformed so that the function of a convex lens is exercised in FIG. 47.

The substrate 202 is previously configured into a convex form, and at least one of the two transparent electrodes 59 is caused to differ in size from the substrate 202, for example, one of the electrodes 59 is made smaller than the substrate 202. In doing so, when the applied voltage is removed, only the opposite preset portions of the two transparent electrodes 59, as shown in FIG. 48, are deformed into concave shapes so as to have the function of a concave lens, acting as the variable focal-length lens.

In this case, since the substrate 202 is deformed so that the volume of the fluid 161 is not changed, there is the advantages that the liquid tank 168 becomes unnecessary.

This example has a great advantage that a part of the substrate 202 holding the fluid 161 is deformed by the piezoelectric substance and the liquid tank 168 is dispensed with.

The transparent substrates 163 and 165 may be constructed as lenses or plane surfaces, although the same may be said of the example of FIG. 46.

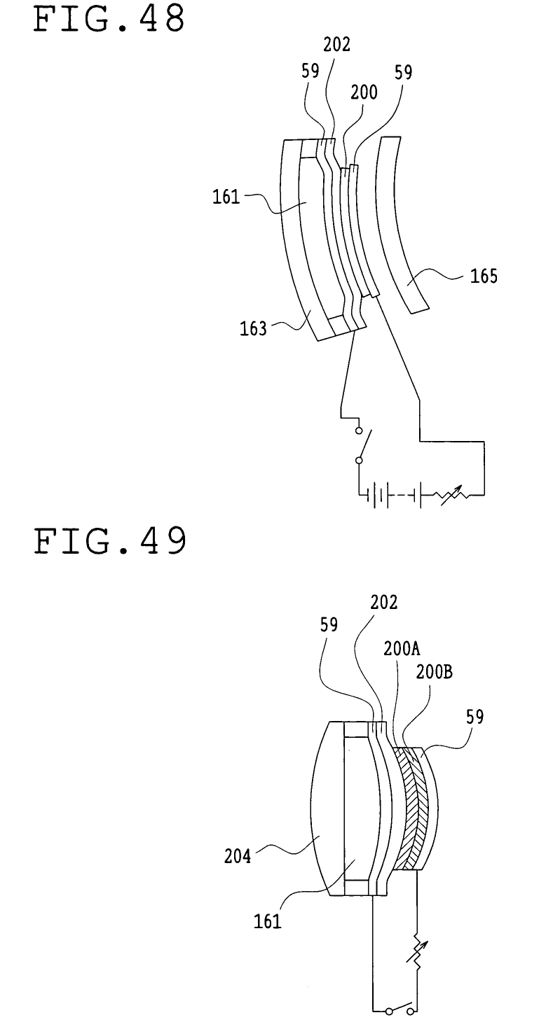

FIG. 49 shows a variable focal-length lens using two thin plates 200A and 200B constructed of piezoelectric substances, in still another example of the variable optical-property element applicable to the optical system of the optical apparatus.

According to this example, the variable focal-length lens has the advantage that the thin plate 200A and the thin plate 200B, reversed in direction of the piezoelectric substance, are used and thereby the amount of deformation is increased so that a wide variable focal-length range can be obtained. Also, in FIG. 49, reference numeral 204 denotes a lens-shaped transparent substrate. Even in the example, the transparent electrode 59 on the right side of the figure is configured to be smaller than the substrate 202.

In the examples of FIGS. 47-49, the thicknesses of the substrate 202, the piezoelectric substance 200, and the thin plates 200A and 200B may be rendered uneven so that a state of deformation caused by the application of the voltage is controlled. This is convenient because lens aberration can also be corrected.

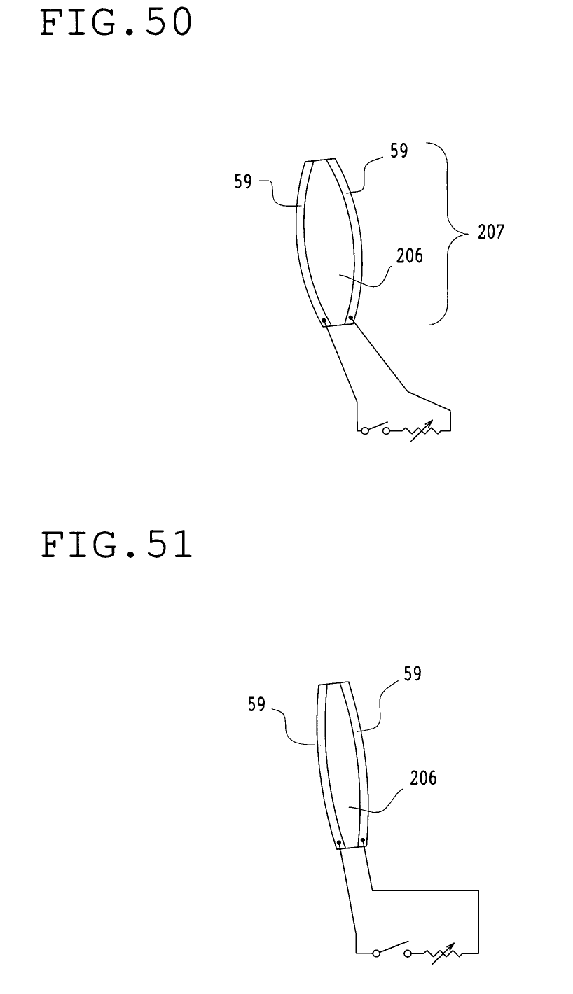

FIG. 50 shows another example of the variable focal-length lens. A variable focal-length lens 207 of this example is constructed of an electrostrictive substance 206 such as silicon rubber or acrylic elastomer.

When the voltage is low, the variable focal-length lens 207 constructed as mentioned above, as depicted in FIG. 50, acts as a convex lens, while when the voltage is increased, the electrostrictive substance 206, as depicted in FIG. 51, expands in a vertical direction and contracts in a lateral direction, and thus the focal length is increased. In this way, the electrostrictive substance 206 operates as the variable focal-length lens. According to the variable focal-length lens of the example, there is the advantage that since a large power supply is not required, power consumption is minimized.

The feature common to the variable focal-length lenses of FIGS. 43-51 mentioned above is that the shape of the medium acting as a lens is changed and thereby a variable focal length can be obtained. Such variable focal-length lenses, in contrast with those in which the refractive index is changed, have the advantage that a variable focal-length range or a lens size can be arbitrarily chosen.

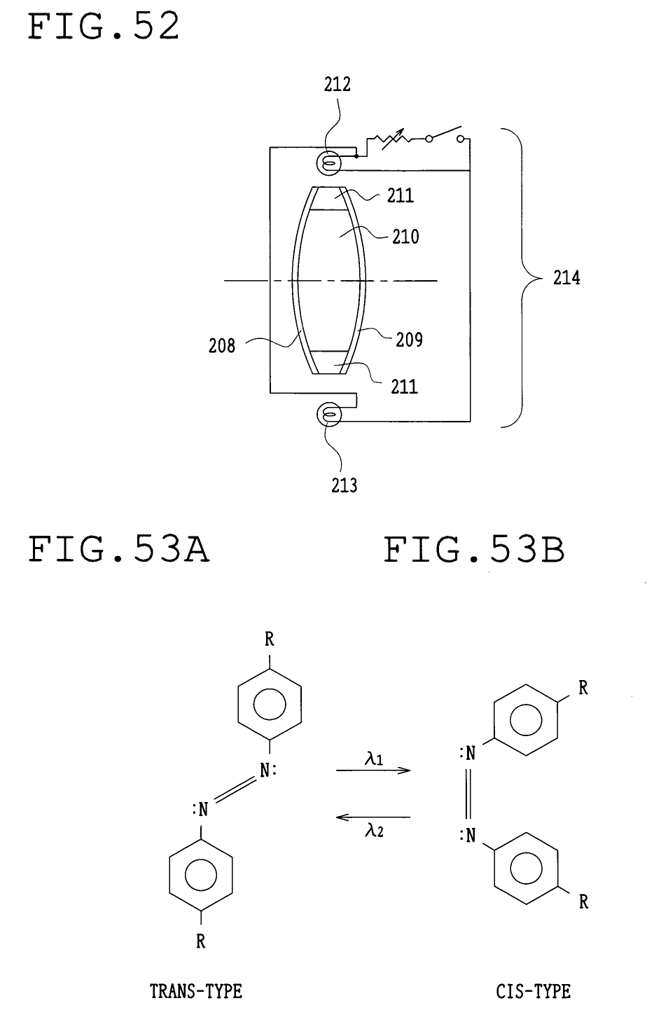

FIG. 52 shows a variable focal-length lens using a photomechanical effect in a further example of the variable optical-property element applicable to the optical system of the optical apparatus. A variable focal-length lens 214 of this example is designed so that azobenzene 210 is sandwiched between transparent elastic bodies 208 and 209 and is irradiated with ultraviolet light through a transparent spacer 211. In FIG. 52, reference numerals 212 and 213 represent ultraviolet light sources, such as ultraviolet LEDs or ultraviolet semiconductor lasers, of central wavelengths λ₁ and λ₂, respectively.

In the example, when trans-type azobenzene shown in FIG. 53A is irradiated with ultraviolet light of the central wavelength λ₁, the azobenzene 210 changes to cis-type azobenzene shown in FIG. 53B to reduce its volume. Consequently, the thickness of the variable focal-length lens 214 is decreased, and the function of the convex lens is impaired.

On the other hand, when the cis-type azobenzene is irradiated with ultraviolet light of the central wavelength λ₂, the azobenzene 210 changes from the cis-type to the trans-type azobenzene to increase the volume. Consequently, the thickness of the variable focal-length lens 214 is increased, and the function of the convex lens is improved. In this way, the optical element 214 of the example acts as the variable focal-length lens.

In the variable focal-length lens 214, since the ultraviolet light is totally reflected at the interface between each of the transparent elastic bodies 208 and 209 and air, the light does not leak through the exterior and high efficiency is obtained.

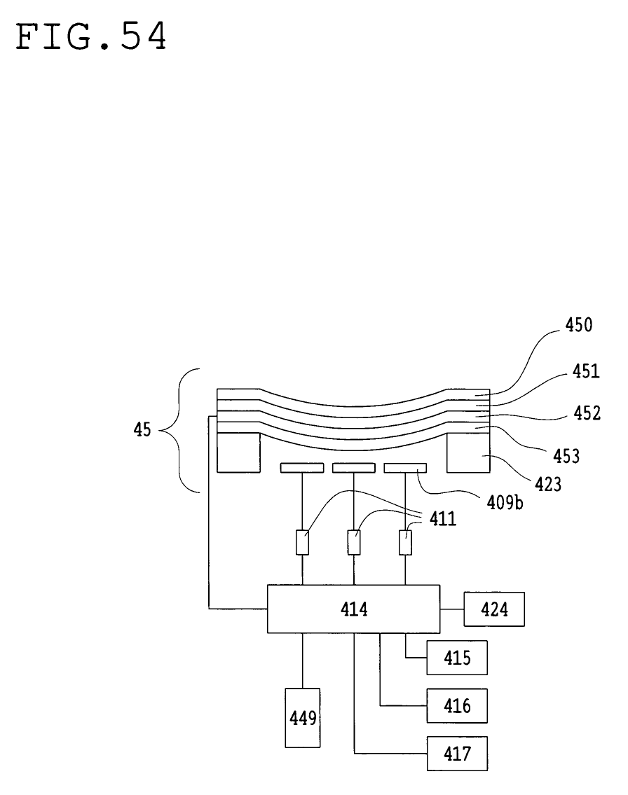

FIG. 54 shows another example of the variable mirror applicable to the optical system of the optical apparatus. This example is described on the assumption that the variable mirror is used in the imaging optical system of the digital camera. Again, in FIG. 54, reference numeral 411 designates the variable resistors housing variable resistors; 414, the arithmetical unit; 415, the temperature sensor; 416, the humidity sensor; 417, the range sensor; and 424, the shake sensor.

A variable mirror 45 of the example is constructed as a four-layer structure in which the divided electrodes 409b are spaced away from an electrostrictive substance 453 including an organic substance such as acrylic elastomer, whose periphery is supported by the support 423, an electrode 452 and a deformable substrate 451 are placed in turn on the electrostrictive substance 453, and a reflecting film 450 including a thin film of metal, such as aluminum, for reflecting incident light is provided on the substrate 451.

The variable mirror 45, when constructed as mentioned above, has the advantages that the surface profile of the reflecting film 450 becomes smooth and it is hard to produce aberration, in contrast to the case where the divided electrodes 409b and the electrostrictive substance 453 are integrally constructed.

Also, the deformable substrate 451 and the electrode 452 may be arranged in reverse order. In FIG. 54, reference numeral 449 stands for a button for the magnification change of the optical system or zooming. The variable mirror 45 is controlled through the arithmetical unit 414 so that a user pushes the button 449 and thereby the reflecting film 450 can be deformed for the magnification change or zooming.

Also, instead of the electrostrictive substance including an organic substance such as acrylic elastomer, the piezoelectric substance such as barium titanate, already mentioned, may be used.

Also, although what follows is said in common with the variable mirror of the present invention, it is desirable that the shape where the portion of deformation of the reflecting surface is viewed from a direction perpendicular to the reflecting surface is long along the direction of the incident plane of an axial ray, for example, elliptical, oval, or polygonal. This is because the variable mirror, as in FIG. 29, is often used in a state where a ray of light is incident at a grazing angle. In order to suppress aberration produced in this case, it is desirable that the reflecting surface has a shape similar to ellipsoid of revolution, paraboloid of revolution, or hyperboloid of revolution. This s because it is desirable that in order to deform the reflecting surface of the deformable mirror into such a shape, the shape where the portion of deformation of the reflecting surface is viewed from a direction perpendicular to the reflecting surface is long along the direction of the incident plane of the axial ray.

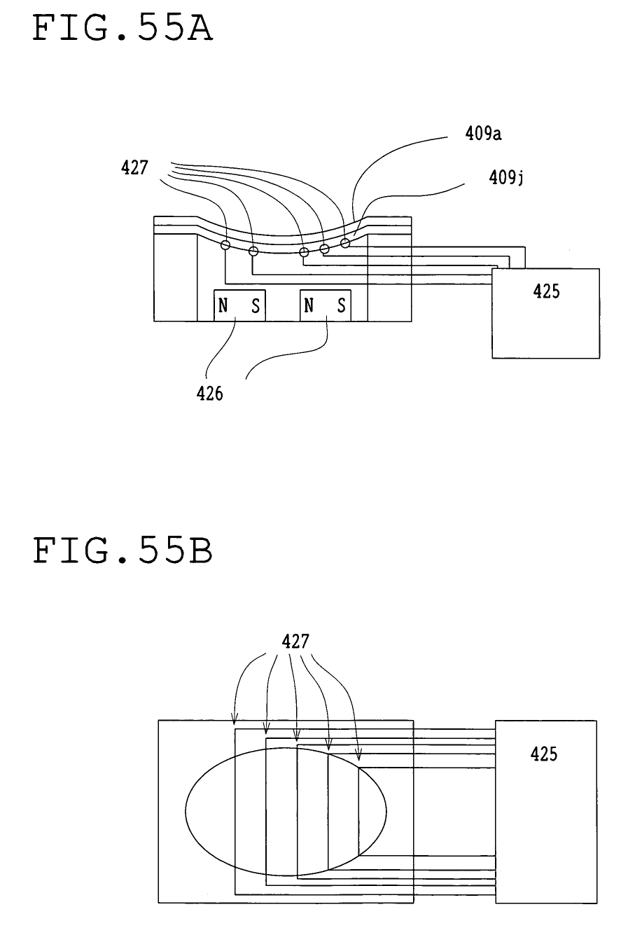

FIGS. 55A and 55B show the structure of an electromagnetic driving variable mirror applicable to the optical system of the optical apparatus. FIG. 55B is a diagram viewed from the opposite side of a reflecting film 409a. Coils (electrodes) 427 are provided to the deformable member 409j to supply the current from a driving circuit and thereby electromagnetic forces are produced in the magnetic fields of permanent magnets 426 so that the shape of the mirror is changed. Since the use of thin film coils facilitates the fabrication of the coils 427 and reduces their rigidity, it is easy to deform the mirror.

The variable focal-length lens shown in each of the embodiments of the present invention can be used in the optical apparatus shown in each of FIGS. 36, 38, 39, and 43.

The present invention has additional features as follows:
(1) The variable optical-property element includes a deformable optical surface, a first electrode constructed integrally with the optical surface, and a second electrode and a third electrode, placed on both sides of the optical surface, at least one of which has an opening for transmitting a utilization light beam. In this case, voltage or current is applied across the first and second electrodes or across the first and third electrodes, thereby changing the property of optical deflection.
(2) In the variable optical-property element of item (1), at least one of the first electrode, the second electrode, and the third electrode is divided into a plurality of segments.
(3) In the variable optical-property element of item (1) or (2), the second electrode or the third electrode is fixed.
(4) In the variable optical-property element of any one of items (1) and (3), a substrate having a plurality of electrodes is provided on one side of the optical surface.
(5) In the variable optical-property element of any one of items (1)-(4), the voltage or current applied across the electrodes is direct or alternating.
(6) The variable optical-property element of any one of items (1)-(5) is constructed as a deformable mirror or a variable focal-length lens.
(7) In the variable optical-property element of any one of items (1)-(6), the optical surface is deformed by an electrostatic force or an electromagnetic force.
(8) The variable optical-property element of any one of items (1)-(7) is designed to satisfy the following condition:
   0.02<S₂/S₁<0.98
   where S₁ is the area of a deformable portion of the optical surface and S₂ is the area of the opening.
(9) The variable optical-property element includes a deformable optical surface; a first electrode divided into a plurality of segments, provided integrally with the optical surface; and a second electrode divided into a plurality of segments, provided on one side of the optical surface. In this case, electric charges of identical signs are stored in at least one set of the first and second electrode, each of which is divided into the plurality of segments, thereby generating the electric force between the divided electrodes to deform the optical surface.
(10) The variable optical-property element of item (9) is constructed so that when the signs of voltages applied to all divided segments of the first electrode are rendered equal, the signs of voltages applied to all divided segments of the second electrode are also rendered equal, and the signs of voltages applied to the first electrode and the second electrode are rendered different, the optical surface can also be deformed.
(11) The variable optical-property element of item (9) or (10) is constricted so that voltages of different signs are applied between the one divided segment of the first electrode and a divided segment adjacent or close to one divided segment of the second electrode, nearly opposite to the divided segment of the first electrode.
(12) The variable optical-property element of any one of items (9)-(11) is constructed so that voltages of different signs are applied between one divided segment of the first electrode or the second electrode and a divided segment adjacent or close to the one divided segment.
(13) The variable optical-property element of any one of claim 10 and items (9)-(12) is designed to satisfy the following condition:
   1/1000000<G/P<300
where G is a distance between the first electrode and the second electrode where the optical surface is flat and P is average center-to-center spacing between adjacent divided segments.
(14) The variable optical-property element of any one of claim 10 and items (9)-(12) is designed to satisfy the following condition:
   1/1000000<G/d<1000
where d is an average distance between adjacent divided segments in the first electrode and the second electrode.
(15) The variable optical-property element of any one of items (9)-(12) is designed to satisfy the following condition:
   0.001<a/A<1
where a is the sum of areas of the divided segments in the first electrode or the second electrode and A is the area of the entire electrode portion.
(16) In the variable optical-property element of any one of claim 10 and items (9)-(15), the division pattern of the first electrode is equal to or different from that of the second electrode.
(17) In the variable optical-property element of any one of claim 10 and items (9)-(16), the first electrode or the second electrode is fixed.
(18) In the variable optical-property element of any one of claim 10 and items (9)-(17), voltages applied to the first and second electrodes are direct or alternating.
(19) The variable optical-property element of any one of items (9)-(18) is constructed as a deformable mirror or a variable focal-length lens.
(20) The variable optical property element of any one of items (9)-(19) is constructed so that the optical surface is formed by the electrostatic force.
(21) The variable optical-property element includes a deformable optical surface, a first electrode provided integrally with the optical surface, and a second electrode provided on one side of the optical surface. The first electrode or the second electrode is divided into a plurality of segments, between which alternating voltage or current is applied, thereby generating a repulsive force or electric force between the first electrode and the second electrode to deform the optical surface.
(22) The variable optical-property element of item 21 further includes a driving circuit in which the frequency of the alternating voltage or current can be changed.
(23) The variable optical-property element includes a deformable optical surface, a first electrode provided integrally with the optical surface, and a second electrode provided on one side of the optical surface. Each of the first electrode and the second electrode is divided into a plurality of segments, between which alternating voltage or current is applied, and thereby a repulsive force or electric force is generated between the first electrode and the second electrode so that the optical surface is deformed and at the same time, a resistor is provided between divided electrodes to which the alternating voltage is not applied.
(24) In the variable optical-property element of item 23, the resistor is variable.
(25) In the variable optical-property element of any one of items (21)-(24), an electrode to which the alternating voltage or current is not applied is made of a material of higher resistance than that to which the alternating voltage or current is applied.
(26) The variable optical-property element of any one of items (21)-(25) is designed to satisfy the following condition:
   1/1000000<G/P<300
where G is a distance between the first electrode and the second electrode where the optical surface is flat and P is average center-to-center spacing between adjacent divided segments.
(27) The variable optical-property element of any one of items (21)-(25) is designed to satisfy the following condition:
1/1000000<G/d<1000
   where d is an average distance between adjacent divided segments in the first electrode and the second electrode.
(28) The variable optical-property element of any one of items (21)-(25) is designed to satisfy the following condition:
0.001<a/A<1
   where a is the sum of areas of the divided segments in the first electrode or the second electrode and A is the area of the entire electrode portion.
(29) In the variable optical-property element of any one of items (21)-(25), the division pattern of the first electrode is nearly equal to or different from that of the second electrode.
(30) The variable optical-property element of any one of items (21)-(25) is constructed as a deformable mirror or a variable focal-length lens.
(31) The variable optical-property element includes a deformable optical surface, a first electrode provided integrally with the optical surface, and a second electrode provided on at least one side of the optical surface. The voltage or current is applied to the first electrode or the second electrode, thereby changing the property of optical deflection. In this case, an electrode provided integrally with a deformable substrate is not parallel with an electrode provided on another electrode.
(32) The variable optical-property element of any one of items (1), (9), (21), and (31) can be used for focusing adjustment of the optical apparatus.
(33) The variable optical-property element of any one of items (1), (9), (21), and (31) can be used for a magnification change of the optical apparatus.
(34) The variable optical-property element of any one of items (9)-(12) or (21)-(25) is designed to satisfy the following condition:
   0.0000001u/G<1000
where G is a distance between the first electrode and the second electrode and u is the thickness of a substrate located between the first electrode and the second electrode.
(35) The variable optical-property element of any one of items (9)-(12) or (21)-(25) is designed to satisfy the following condition:
   0.0000001≦Δ/G≦1000
where A is a distance between the optical surface and the first electrode.
(36) The variable optical-property element includes a deformable optical surface, a first electrode provided integrally with the optical surface, and a second electrode provided on one side of the optical surface in such a way that a utilization light beam is partially blocked. The voltage or current is applied between the first electrode and the second electrode and thereby the property of optical deflection can be changed.
(37) The variable optical-property element of item 36 includes a third electrode on the opposite side of the second electrode with respect to the deformable optical surface. The voltage or current is applied between the first electrode and the second electrode or between the first electrode and the third electrode, and thereby the property of optical deflection can be changed.
(38) The variable optical-property element of item 36 includes a third electrode on the opposite side of the second electrode with respect to the first electrode. The voltage or current is applied between the first electrode and the second electrode or Is between the first electrode and the third electrode, and thereby the property of optical deflection can be changed.
(39) The variable optical-property element of item 36 is designed to satisfy the following condition:
   0.01≦f≦0.5
where f is the ratio of an area that a light beam to be transmitted is blocked by the second electrode to the entire area of the light beam to be transmitted.
(40) The variable optical-property element includes a deformable optical surface and a plurality of electrodes provided integrally with the optical surface. The optical surface is deformed by an electric force generated between the electrodes so that the property of optical deflection can be changed.
(41) The variable optical-property element of item 40 includes a deformable optical surface, a plurality of electrodes provided integrally with the optical surface, and driving circuits storing electric charges in the electrodes so that the optical surface is deformed by an electric force generated between the electrodes and the property of optical deflection can be changed.
(42) The variable optical-property element includes a deformable optical surface with conductivity and a plurality of electrodes provided integrally with the optical surface. The optical surface with conductivity is divided in accordance with the plurality of electrodes.
(43) The variable optical-property element of item 42 includes the second electrode opposite to the plurality of electrodes.
(44) The variable optical-property element of item 42 includes the second electrode on one side of the optical surface.
(45) The variable optical-property element of any one of items (42) and (44) is designed to satisfy the following condition:
   0.000001≦t/\sqrt{w}≦10000
where t is a thickness of each of the first electrode and the second electrode and w is an area thereof.
(46) The variable optical-property element of item (9) or (22) is constructed so that the electric force is a repulsive force and thereby the property of optical deflection can be changed.
(47) The variable optical-property element includes a deformable optical surface, a first electrode provided integrally with the optical surface, and a second electrode provided on one side of the optical surface so that an electric force or repulsive force is generated by applying current or voltage between the first electrode and the second electrode, and the property of optical deflection can be changed.
(48) The variable optical-property element of item 47 is constructed so that the applied current or voltage is alternating and thereby the property of optical deflection can be changed.
(49) The variable mirror has a reflecting surface and a member placed in the proximity of the reflecting surface. The reflecting surface is divided into a plurality of segments.
(50) The variable mirror includes a deformable reflecting surface so that the reflecting surface can be deformed into either a convex or concave shape and at least one of a fluid, electrostatic force, electric field, electromagnetic force, piezoelectric effect, magnetrostriction, temperature change, and electromagnetic wave are used to deform the reflecting surface.
(51) The variable mirror includes a deformable reflecting surface so that the reflecting surface can be deformed into either a convex or concave shape and when the reflecting surface is deformed into a convex shape, the pressure of the fluid is used, while when it is deformed into a concave shape, the electric force is used.
(52) The imaging apparatus has the variable mirror of item (50) or (51) so that when the surface profile of the variable mirror is flat, an object at any distance from the infinity to 0.5 meters is brought to a focus.
(53) The optical apparatus has the variable optical-property element of any one of items (2)-(8), a shake sensor, and an image sensor so that the optical surface of the variable optical-property element is deformed to thereby make compensation for shake.
(54) The optical apparatus has the variable optical-property element of any one of items (2)-(8) so that the optical surface of the variable optical-property element is deformed to thereby make compensation for at least one of a temperature change, a humidity change, a manufacturing error, and a change with age.

Finally, the definitions of terms used in the present invention will be described.

The optical apparatus refers to an apparatus including an optical system or optical elements. The optical apparatus need not necessarily function by itself. That is, it may be thought of as a part of an apparatus.

An imaging apparatus, an observation apparatus, a display apparatus, an illumination apparatus, a signal processor, and an optical information processor come into the category of the optical apparatus.

The imaging apparatus refers to, for example, a film camera, a digital camera, a digital camera for PDAs, a robot's eye, a lens-exchangeable digital single-lens reflex camera, a TV camera, a moving-picture recorder, an electronic moving-picture recorder, a camcorder, a VTR camera, a digital camera of a mobile phone, a TV camera of a mobile phone, an electronic endoscope, a capsule endoscope, a vehicle mounted camera, a camera of an artificial satellite, a camera of a planet probe, a camera of a space probe, a monitor camera, and eyes for various sensors. Any of the digital camera, a card digital camera, the TV camera, the VTR camera, a moving-picture recording camera, the digital camera of a mobile phone, the TV camera of a mobile phone, the vehicle mounted camera, the camera of an artificial satellite, the camera of a planet probe, and the camera of a space probe, is an example of an electronic imaging apparatus.

The observation apparatus refers to, for example, a microscope, a telescope, spectacles, binoculars, a magnifier, a fiber scope, a finder, or a viewfinder.

The display apparatus includes, for example, a liquid crystal display, a viewfinder, a game machine (Play Station by Sony), a video projector, a liquid crystal projector, a head mounted display (HMD), a personal digital assistant (PDA), or a mobile phone.

The illumination apparatus includes, for example, a stroboscopic lamp for cameras, a headlight for cars, a light source for endoscopes, or a light source for microscopes.

The signal processor refers to, for example, a mobile phone, a personal computer, a game machine, a read/write apparatus for optical disks, an arithmetic unit for optical computers, an optical interconnector, an optical information processor, or a PDA.

An information transmitter refers to an apparatus which is capable of inputting and transmitting any information from a mobile phone; a stationary phone; a remote control for game machines, TVs, radio-cassette tape recorders, or stereo sound systems; a personal computer; or a keyboard, mouse, or touch panel for personal computers. It also includes a TV monitor with the imaging apparatus, or a monitor or display for personal computers. The information transmitter comes into the category of the signal processor.

The image sensor refers to, for example, a CCD, a pickup tube, a solid-state image sensor, or a photographing film. The plane-parallel plate is thought of as one of prisms. A change of an observer includes a change in diopter. A change of an object includes a change in object distance. The displacement of the object includes a change of the object distance of an object to be photographed, the movement of the object, vibration, or the shake of the object.

An extended surface is defined as follows:

Any shape such as a spherical, planar, or rotationally symmetrical aspherical surface; a spherical, planar, or rotationally symmetrical aspherical surface which is decentered with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. is satisfactory. Moreover, any surface which has some effect on light, such as a reflecting or refracting surface, is satisfactory. In the present invention, it is assumed that such a surface is generally referred as to the extended surface.

The variable optical-property element includes a variable focal-length lens, a variable mirror, a deflection prism whose surface profile is changed, a variable angle prism, or a variable diffraction optical element in which the function of light deflection is changed, namely a variable HOE, or a variable DOE.

The variable focal-length lens also includes a variable lens such that the focal length is not changed, but the amount of aberration is changed. The variable mirror includes a mirror such that the focal length is not changed, but the amount of aberration is changed. The variable focal-length lens includes a mirror provided with a reflecting surface, a variable focal-length mirror whose shape is not changed, or a deformable mirror whose shape is changed. In a word, an optical element in which the function of light deflection, such as reflection, refraction, or diffraction, can be changed is called the variable optical-property element.

1. A variable optical-property element comprising:
a plurality of electrodes;
a substrate driven by electric force and deformed into a convex shape;
an electrode constructed integrally with the substrate;
an optical surface provided on the substrate; and
a driving circuit connected to the electrodes.

2. A variable optical-property element comprising:
a deformable optical surface;
a first electrode constructed integrally with the optical surface; and
a second electrode and a third electrode, placed on both sides of the optical surface, at least one of which has an opening for transmitting a utilization light beam,
voltage or current being applied across the first electrode and the second electrode or across the first electrode and the third electrode, thereby changing a property of optical deflection.

3. A variable optical-property element according to claim 2, wherein the variable optical-property element is a variable mirror.

4. A variable optical-property element comprising:
a deformable optical surface;
a first electrode divided into a plurality of segments, provided integrally with the optical surface; and
a second electrode divided into a plurality of segments, provided on one side of the optical surface,
electric charges of identical signs being stored in at least one set of the first electrode and the second electrode, each of which is divided into the plurality of segments, thereby generating electric forces between the divided electrodes to deform the optical surface.

5. A variable optical-property element comprising:
a deformable optical surface;
a first electrode provided integrally with the optical surface; and
a second electrode provided on one side of the optical surface,
the first electrode or the second electrode being divided into a plurality of segments, between which alternating voltage or alternating current is applied, thereby generating a repulsive force or electric force between the first electrode and the second electrode to deform the optical surface.

6. A variable optical-property element comprising:
a deformable optical surface,
a first electrode provided integrally with the optical surface; and
a second electrode provided on one side of the optical surface,
each of the first electrode and the second electrode being divided into a plurality of segments, between which alternating voltage or alternating current is applied, there-by generating a repulsive force or electric force between the first electrode and the second electrode so that the optical surface is deformed and at the same time, a resistor is provided between divided electrodes to which no alternating voltage is applied.

7. A variable optical-property element comprising:
a deformable optical surface;
a first electrode provided integrally with the optical surface; and
a second electrode provided on at least one side of the optical surface,
voltage or current being applied to the first electrode or the second electrode, thereby changing a property of optical deflection,
wherein an electrode provided integrally with a deformable substrate is nonparallel with an electrode provided on a remaining electrode.

8. A variable optical-property element according to any one of claims 2, 4, 5, or 7, wherein the variable optical-property element is used for compensation for shake of an optical apparatus.

9. A variable optical-property element according to any one of claims 2, 4, 5, or 7, wherein the variable optical-property element is used for compensation for one of a temperature change, a humidity change, a manufacturing error, and a change with age of an optical apparatus.

10. A variable optical-property element according to any one of claims 4-5, satisfying the following condition:
0.000001≦t/\sqrt{w}≦10000
where t is a thickness of each of the first electrode and the second electrode and w is an area thereof.

11. An optical apparatus including an optical system provided with a variable optical-property element having a plurality of divided electrodes, wherein a voltage distribution different from symmetrization of the optical system can be imparted to the electrodes.

12. A variable optical-property element comprising:
a deformable optical surface;
a first electrode provided integrally with the optical surface; and
a second electrode provided on one side of the optical surface in such a way that a utilization light beam is partially blocked,
voltage or current being applied between the first electrode and the second electrode, thereby changing a property of optical deflection.

13. A variable optical-property element comprising:
a deformable optical surface; and
a plurality of electrodes provided integrally with the optical surface,
the optical surface being deformed by an electric force generated between the electrodes so that a property of optical deflection can be changed.

14. A variable optical-property element according to claim 13, wherein electric charges of different signs are stored in the plurality of electrodes.

15. A variable optical-property element changing a property of optical deflection, comprising:
a deformable optical surface with conductivity; and
a plurality of electrodes provided integrally with the optical surface,
the optical surface with conductivity being divided in accordance with the plurality of electrodes.

16. A variable optical-property element changing a property of optical deflection according to any one of claims 4, 5, 7, or 13, wherein the deformable optical surface has conductivity, and the optical surface with conductivity is divided in accordance with the first electrode.

17. A variable optical-property element comprising:
a deformable optical surface;
a first electrode provided integrally with the optical surface; and
a second electrode provided on one side of the optical surface,
an electric force or repulsive force being generated by applying electric charges of identical signs between the first electrode and the second electrode to change a property of optical deflection.

18. A variable optical-property element comprising:
a deformable optical surface;
a first electrode provided integrally with the optical surface; and
a second electrode provided on one side of the optical surface,
an electric force or repulsive force is generated by applying current or voltage between the first electrode and the second electrode to change a property of optical deflection.

19. A variable optical-property element comprising:
a deformable optical surface;
a first electrode divided into a plurality of segments, provided integrally with the optical surface; and
a second electrode divided into a plurality of segments, provided on one side of the optical surface,
a repulsive force being generated between divided electrodes by storing electric charges of identical signs between the first electrode and the second electrode, divided practically opposite to each other, to deform the optical surface.

20. A variable mirror comprising:
a deformable portion having a reflecting surface and a substrate; and
an electrode placed opposite to the substrate,
the reflecting surface being divided into a plurality of segments and driven by an electric force.

21. A variable mirror comprising:
a deformable portion having a reflecting surface and a substrate; and
an electrode placed opposite to the substrate,
the reflecting surface being divided into a plurality of segments and having an electrode function,
the reflecting surface being driven by an electric force.

22. A variable mirror having a deformable reflecting surface, wherein the reflecting surface can be deformed into either a convex or concave shape and at least one of a fluid, electrostatic force, electric field, electromagnetic force, piezoelectric effect, magnetrostriction, temperature change, and electromagnetic wave is used to deform the reflecting surface.

23. A variable mirror having a deformable reflecting surface, wherein the reflecting surface can be deformed into either a convex or concave shape and when the reflecting surface is deformed into a convex shape, a pressure of a fluid is used, while when the reflecting surface is deformed into a concave shape, an electric force is used.

24. An imaging apparatus having a variable mirror provided with a deformable reflecting surface, wherein when a surface profile of the variable mirror is flat, an object at a distance that a far point of a depth of field becomes nearly infinite is brought to a focus.

25. An imaging apparatus having a variable mirror provided with a deformable reflecting surface, wherein the reflecting surface assumes both concave and convex shapes in a focusing process.

26. A variable focal-length lens having a deformable optical surface, wherein the optical surface can be deformed into either a convex or concave shape and at least one of a fluid, electrostatic force, electric field, electromagnetic force, piezoelectric effect, magnetrostriction, temperature change, and electromagnetic wave is used to deform the optical surface.

27. A variable focal-length lens having a deformable optical surface, wherein the optical surface can be deformed into either a convex or concave shape and when the optical surface is deformed into a convex shape, a pressure of a fluid is used, while when the optical surface is deformed into a concave shape, an electric force is used.

28. An imaging apparatus having a variable focal-length lens provided with a deformable optical surface, wherein when a surface profile of the variable focal-length lens is flat, an object at a distance that a far point of a depth of field becomes nearly infinite is brought to a focus.

29. An imaging apparatus having a variable focal-length lens provided with a deformable optical surface, wherein when a surface profile of the variable focal-length lens is flat, an object at any distance from infinity to 0.5 meters is brought to a focus.

30. An imaging apparatus having a variable focal-length lens provided with a deformable optical surface, wherein the optical surface assumes both concave and convex shapes in a focusing process.

31. An optical apparatus comprising:
a variable optical-property element;
a shake sensor; and
an image sensor,
the variable optical-property element comprising:
a deformable optical surface;
a first electrode constructed integrally with the optical surface; and
a second electrode and a third electrode, placed on both sides of the optical surface, at least one of which has an opening for transmitting a utilization light beam,
voltage or current being applied across the first electrode and the second electrode or across the first electrode and the third electrode, thereby changing a property of optical deflection,
wherein the optical surface of the variable optical-property element is deformed and thereby compensation for shake is made.

32. An optical apparatus having a variable optical-property element,
the variable optical-property element comprising:
a deformable optical surface;
a first electrode constructed integrally with the optical surface; and
a second electrode and a third electrode, placed on both sides of the optical surface, at least one of which has an opening for transmitting a utilization light beam,
voltage or current being applied across the first electrode and the second electrode or across the first electrode and the third electrode, thereby changing a property of optical deflection,
wherein the optical surface of the variable optical-property element is deformed and thereby at least one of a temperature change, a humidity change, a manufacturing error, and a change with age is compensated.
